(19) United States
(12) Patent Application Publication
(10) Pub. No.: US 2006/0214503 A1
(43) Pub. Date: Sep. 28, 2006

(54) FREIGHT RAILROAD CAR REFLECTOR

(75) Inventors: Daniel L. Hart, Antioch, IL (US); John D. Anderson, Aurora, IL (US); Walter J. Peach, South Elgin, IL (US)

Correspondence Address: BELL, BOYD & LLOYD, LLC, PO BOX 1135, CHICAGO, IL, 60690-1135, US

(73) Assignee: ZefTek, Inc., Montgomery, IL (US)

(21) Appl. No.: 11/277,216

(22) Filed: Mar. 22, 2006

Related U.S. Application Data
(60) Provisional application No. 60/664,303, filed on Mar. 22, 2005.

(51) Int. Cl. B60T 8/18

(52) U.S. Cl. 303/22.2

(57) ABSTRACT

A freight railroad car equipped with a plurality of spaced apart reflector apparatus which can be easily and readily installed on the freight railroad car in shorter time periods than the previously known adhesive backed reflective tape. One embodiment of the freight railroad car reflector apparatus includes a mounting member, a reflector material attached to the mounting member and a plurality of fasteners or attachment mechanisms used to attach the mounting member to the freight railroad car.

### PRIORITY CLAIM

This application is a non-provisional application of, claims the benefit of and priority to U.S. Provisional Application Ser. No. 60/664,303, filed Mar. 22, 2005, the entire contents of which are incorporated herein.

### BACKGROUND

Thousands of people are hurt or killed at railroad crossings each year. Railroad crossings in urban and suburban areas usually have conventional warning systems such as lighting systems and/or gates which block entry to the railroad tracks when trains approach and pass through the crossings. However, many railroad crossings in rural areas do not have any warning systems. These crossings usually have signs to alert drivers of vehicles that they are about to cross over railroad tracks. During daylight hours, these signs and the tracks are usually readily visible. During night time hours, these signs and the tracks are much less visible, and sometimes based on conditions hardly visible at all.

Conventional freight railroad cars are not illuminated and are not equipped or constructed with reflective materials. During night time hours, many accidents occur simply because the drivers of vehicles cannot see the dark freight railroad cars and do not know that freight railroad cars are running through the crossing. These vehicles simply run into the moving railroad cars. This problem for vehicles (as well as for snowmobiles and ATV's) is so common that on Jan. 3, 2005, the United Sates Federal Railroad Administration issued final regulations mandating that reflective material be placed on all freight railroad cars within ten years or by 2015 at least according to a minimum schedule set forth in the regulations. The regulations are 49 CFR Part 224 entitled “Reflectorization of Rail Freight Rolling Stock; Final Rule.” These regulations further describe the extent of the existing problems. These regulations require railroads to place reflective material of minimum designated sizes on the freight railroad cars at minimum spaced apart designated positions.

This is an extraordinarily large and expensive undertaking for the railroads because there are over 1.6 million freight railroad cars and locomotives in North America. For purposes of this application, the term freight railroad cars includes locomotives. Each railroad car will have approximately 14 to 22 pieces of reflective material mounted on that railroad car. Thus, between 22 million and 35 million pieces of reflective material will need to be mounted on the freight railroad cars. Equipping the large number of freight railroad cars in accordance with these regulations has been and continues to be an extremely slow process, in part because the railroads are equipping their freight cars by directly placing adhesive backed reflective tape on portions of the freight railroad cars such as the frames and side walls of the freight railroad cars. There are several problems with attaching such reflective tape directly to the freight railroad cars. One problem is that the freight railroad cars must be taken out of service for a relatively significant amount of time during the attachment process. Another problem is that the freight railroad cars are usually extremely dirty and must be cleaned before the adhesive backed reflective tape is directly placed on the freight railroad cars for proper adherence. Another problem is the freight railroad cars tend to be rusty and the adhesive backed tape does not adhere to rust very well. This cleaning may include washing, sanding, blasting, grinding, painting and drying processes. The cleaning can take several hours for each freight railroad car. This cleaning is thus extremely time consuming, inefficient and expensive. This overall process of directly attaching adhesive backed reflective tape to each freight railroad car can take between 2 to 5 hours. This is a substantial man-hour cost. These problems dramatically slow the entire process of equipping the 1.6 million freight railroad cars according to the regulations.

To avoid these problems and significant costs, some railroads may be directly applying reflective tape to the dirty freight railroad cars to save time and cost. The problem with this is that the adhesive backed reflective tape is much more likely to not stick to, peel off or otherwise come off such dirty or rusty surfaces, and thus result in a freight railroad car without the necessary reflective material according to the regulations. After the reflective material comes off, it is less likely to be put back on in a short time period.

A further problem is that the adhesive backed reflective tape is preferably applied when the temperature is above 50 degrees Fahrenheit. If the temperature is significantly below 40 degrees Fahrenheit, and particularly if the surface of the freight railroad car is below 40 degrees Fahrenheit, then the adhesive backed reflective tape may not readily stick to the surface of the freight railroad car. Similarly, a further problem is that it is difficult to apply the reflective tape in bad weather such as rain or snow. This also dramatically increases the time and cost of equipping freight railroad cars according to the regulations.

Another problem with directly applying reflective tape to the freight railroad cars is that many surfaces of the freight railroad cars are not flat because they have been dented or otherwise damaged. This can further slow down the installation process and can cause the reflective tape to peel or otherwise come off more readily. A further problem is that the adhesive backed reflective tape directly applied to the railroad is not protected and is subject to external forces which can cause damage to the reflective tape.

Accordingly, there is a need for a much easier, much faster and less expensive method and apparatus for equipping freight railroad cars with reflective material according to the regulations.

Additionally, there is a need for a method and apparatus that will encourage railroads to equip their freight railroad cars ahead of the schedule required by the regulations.

### SUMMARY OF THE INVENTION

The present invention provides a much faster, much more cost efficient and much easier apparatus and method for equipping freight railroad cars in accordance with the regulations set forth in 49 CFR Part 224. In one embodiment, the present invention provides a plurality of freight railroad car reflectors or reflector apparatus which are each attached to a freight railroad car at spaced apart locations along the exterior side walls of the freight railroad car. The freight railroad car reflectors are each suitably sized and can each be attached horizontally, vertically or otherwise in accordance with the regulations. Each freight railroad car reflector or reflector apparatus can be easily and quickly attached to the freight railroad car without the need to clean the freight railroad car and without the need for the temperature being at minimum levels or the weather being otherwise good. Moreover, the freight railroad cars may not need to be taken out of service or only taken out of service for a relatively short period of time.

One embodiment of the railroad car reflector apparatus of the present invention includes a mounting member, a reflector or reflector material attached to the mounting member and one or more fasteners or attachment mechanisms used to easily and quickly attach the railroad car reflectors to the freight railroad car. In one embodiment, the fasteners or attachment mechanisms are inserted though mounting apertures in the mounting member of the railroad car reflector and into existing holes in the freight railroad cars such as in the side wall screens of autorack railroad cars. In other embodiments, the fastener or attachment mechanism is maintained by the mounting member. In one such embodiment, the fasteners or attachment mechanisms include weld washers integrally formed with the mounting members of the railroad car reflector to facilitate quick welding of the railroad car reflector to the freight railroad car. In further embodiments, the fasteners or attachment mechanisms such as weld washers are configured to be easily attached to and removably held by the mounting members to facilitate quick welding of the railroad car reflector to the freight railroad car. These embodiments provide apparatus and methods for easy assembly of the attachment mechanisms and the mounting members and thus simplify the manufacturing process and installation procedures of the railroad car reflector. Other suitable attachment mechanisms can be employed in accordance with the present invention. The present invention thus contemplates a method of attaching reflective material to freight railroad cars in an easy, cost efficient, and effective manner.

The present invention thus contemplates a freight railroad car and particularly an improved freight railroad car equipped with a plurality of spaced apart reflector apparatus. The present invention further contemplates that because the reflector apparatus of the present invention can be easily and readily installed in shorter time periods than the previous direct attachment of the adhesive backed reflective tape, that more railroad cars can be more quickly installed with these reflector apparatus and that less accidents can occur and that less people will be hurt or killed.

Additional features and advantages of the present invention are described in, and will be apparent from, the following Detailed Description of the Invention and the figures.

### BRIEF DESCRIPTION OF THE DRAWINGS

FIG. 1 is a side view of a conventional freight railroad car.

FIG. 2 is a side view of a conventional autorack railroad car.

FIG. 3 is a front perspective view of a railroad car reflector apparatus of one embodiment of the present invention.

FIG. 4 is a front perspective view of the railroad car reflector apparatus of FIG. 3 showing the fasteners mounted in the mounting apertures.

FIG. 5 is a rear perspective view of the railroad car reflector apparatus of FIG. 3 showing the fasteners mounted in the mounting apertures.

FIG. 6 is a side view of a conventional autorack railroad car with a plurality of railroad car reflector apparatus of FIG. 3 mounted along one of the side walls in vertical and horizontal positions.

FIGS. 6A and 6B are side views of alternative freight railroad cars each with a plurality of railroad car reflector apparatus of one embodiment of the present invention mounted along one of the side walls.

FIG. 7 is a front perspective view of the railroad car reflector apparatus of another embodiment of the present invention with a portion of the reflective material broken away to show the reflector supporter.

FIG. 8 is a rear perspective view of the railroad car reflector apparatus of FIG. 7.

FIG. 9 is a side view of a conventional freight railroad car with a plurality of railroad car reflector apparatus of FIG. 7 mounted along one of the side walls in vertical and horizontal positions.

FIG. 10 is a front perspective view of the railroad car reflector apparatus of another embodiment of the present invention with a portion of the reflective material broken away to show the reflector supporter.

FIG. 11 is an enlarged fragmentary front perspective view of the railroad car reflector apparatus of FIG. 10 showing a weld washer molded in a mounting section.

FIG. 12 is a front perspective view of the railroad car reflector apparatus of another embodiment of the present invention.

FIG. 13 is a front perspective view of the railroad car reflector apparatus of another embodiment of the present invention.

FIG. 14 is a front perspective view of the railroad car reflector apparatus of another embodiment of the present invention.

FIG. 15 is a rear perspective view of the railroad car reflector apparatus of FIG. 14.

FIG. 16 is a front perspective view of the railroad car reflector apparatus of another embodiment of the present invention.

FIG. 17 is a rear perspective view of the railroad car reflector apparatus of FIG. 16.

FIG. 18 is a front perspective view of the railroad car reflector apparatus of another embodiment of the present invention.

FIG. 19 is a front perspective view of the railroad car reflector apparatus of another embodiment of the present invention.

FIG. 20 is a front perspective view of the railroad car reflector apparatus of another embodiment of the present invention.

FIG. 21 is a front perspective view of the railroad car reflector apparatus of another embodiment of the present invention.

FIG. 22 is a front perspective view of the railroad car reflector apparatus of another embodiment of the present invention with a portion of the reflective material broken away to show the reflector supporter, and which is configured to removably hold a plurality of weld washers in the upper and lower mounting sections.

FIG. 23 is an enlarged fragmentary front perspective view of the upper mounting section of the railroad car reflector apparatus of the embodiment of FIG. 22 with a portion of the reflective material broken away to show the reflector supporter.

FIG. 24 is a front perspective view of the railroad car reflector apparatus of the embodiment of FIG. 22 with a portion of the reflective material broken away to show the reflector supporter, showing the weld washers mounted in the upper and lower mounting sections.

FIG. 25 is an enlarged fragmentary front perspective view of the upper mounting section of the railroad car reflector apparatus of the embodiment of FIG. 22 with a portion of the reflective material broken away to show the reflector supporter, showing a weld washer mounted in the upper mounting section.

FIG. 26 is a front perspective view of the railroad car reflector apparatus of another embodiment of the present invention with a portion of the reflective material broken away to show the reflector supporter, and which is configured to removably hold a plurality of weld attachment mechanisms such as washers.

FIG. 27 is an enlarged fragmentary front perspective view of the upper section of the railroad car reflector apparatus of the embodiment of FIG. 26 with a portion of the reflective material broken away to show the reflector supporter, and showing a weld washer mounted in the upper mounting section.

FIG. 28 is a rear perspective view of the railroad car reflector of FIG. 26.

FIG. 29 is a front perspective view of another alternative embodiment of the railroad car reflector apparatus of the present invention with a portion of the reflective material broken away to show the reflector supporter.

FIG. 30 is an enlarged fragmentary front perspective view of the railroad car reflector apparatus of FIG. 29 with a portion of the reflective material broken away to show the reflector supporter.

### DETAILED DESCRIPTION OF THE INVENTION

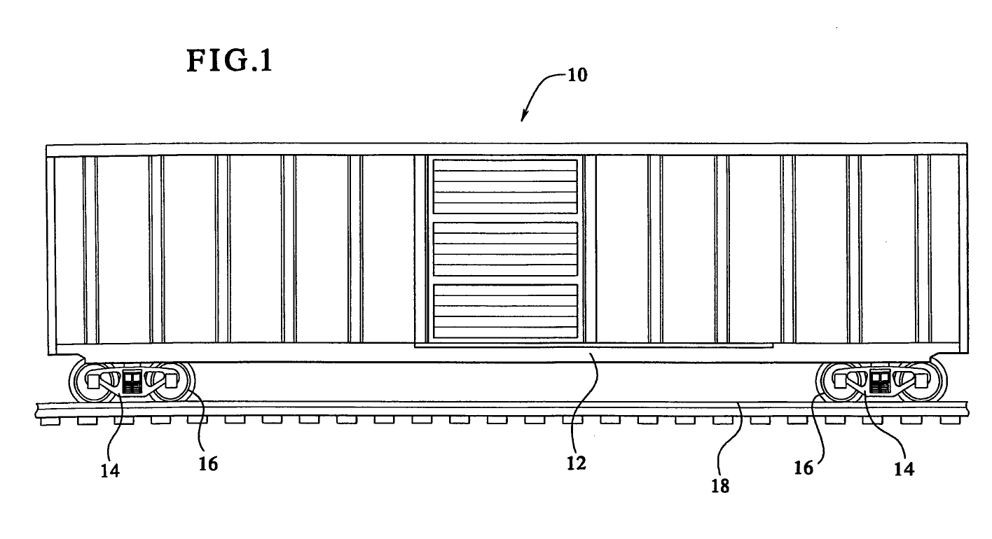

Referring now to the figures, FIG. 1 illustrates one type of freight railroad car 10. There are numerous different types of freight railroad cars. The present invention can be employed on any freight railroad car. The freight railroad car 10 includes a frame 12 supported by trucks 14, each of which have several wheels 16 which roll along railroad tracks 18. The frame 12 supports the load transported by the freight railroad car. Freight railroad cars vary in the frame and the structure above the frame depending upon the transported products. For instance, box cars usually have four walls including spaced-apart opposing side walls, spaced-apart opposing end walls, a roof attached to the walls and at least one door. The door provides access to the interior storage compartment defined by the walls and roof.

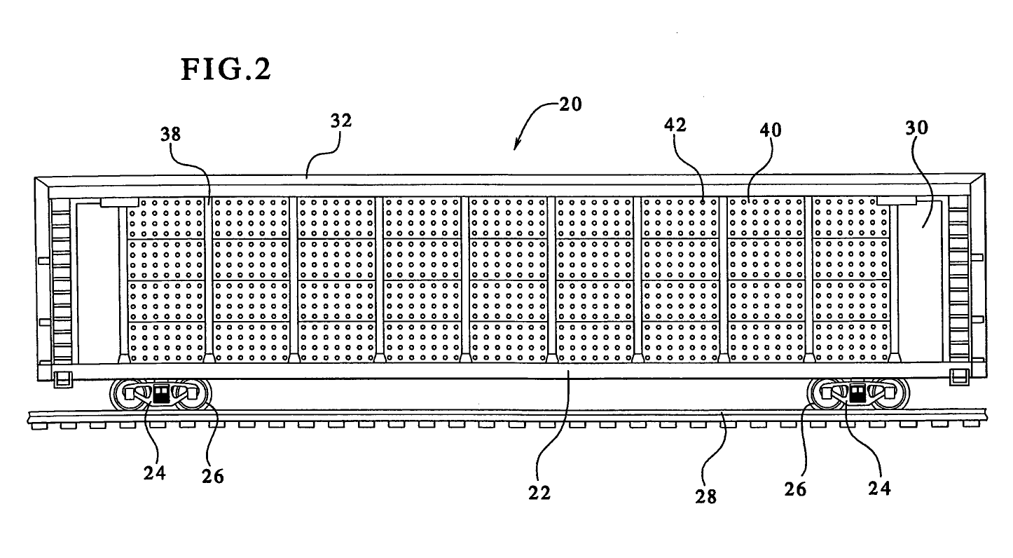

Another known type of freight railroad car is an autorack railroad car 20 generally illustrated in FIG. 2. The autorack railroad car 20 includes a frame 22 supported by trucks 24, each of which have several wheels 26 which roll along railroad tracks 28. The frame 22 supports two sidewalls 30 and a roof 32. The autorack car includes a pair of co-acting clamshell doors mounted on each end of the autorack car. The doors are opened to facilitate the loading and unloading of vehicles into and out of the autorack car and are closed during transport or storage of the vehicles.

The sidewalls of an autorack railroad car includes a series of steel vertical posts 38 which are mounted on and extend upwardly from the frame 22. The roof 32 is mounted on and supported by these vertical posts. The vertical posts are spaced along the entire length of both sidewalls of the autorack car. A plurality of rectangular galvanized steel sidewall panels 40 which extend horizontally and are vertically spaced apart are mounted between each pair of vertical posts 38. These sidewall panels are supported at their corners by brackets (not shown) that are suitably secured to the vertical posts. The average sidewall panel has a multiplicity of round sidewall panel holes 42. These sidewall panel holes 42 provide the autorack car with natural light as well as proper ventilation. Proper ventilation prevents harm from the toxic vehicle fumes to the person or persons loading or unloading the vehicles into or out of the autorack car.

The autorack car may be a tri-level car having first, second and third levels. Normally, eighteen passenger vehicles can be transported in a tri-level autorack car, six on each level. The autorack car can also have two levels for vehicles instead of three. The bi-level autorack car has a lower level and an upper level. The bi-level autorack car is generally used to transport larger vehicles, such as vans, mini-vans, pickup trucks, four-by-four and cross-over vehicles. The bi-level autorack car can usually transport twelve of these vehicles, six on each level. The autorack car may also be a single-level car.

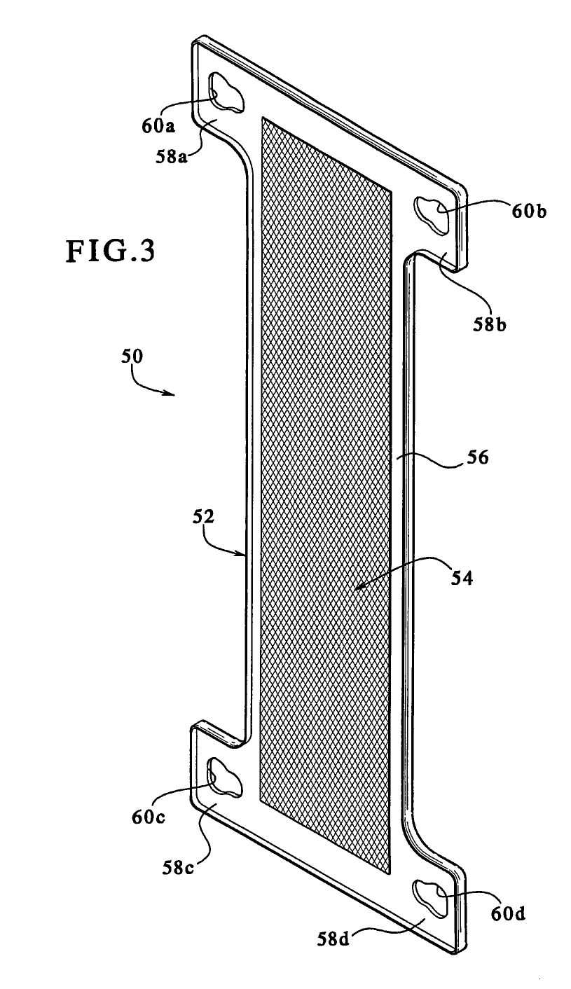

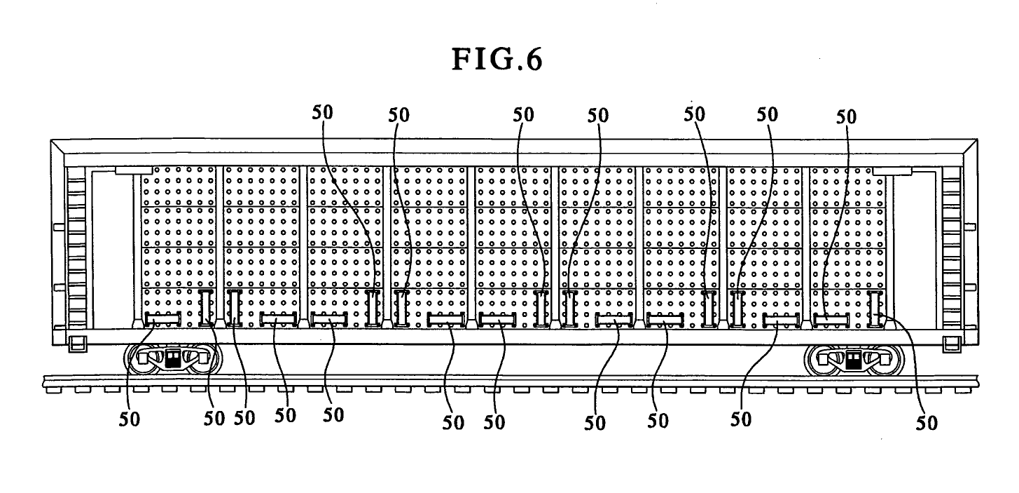

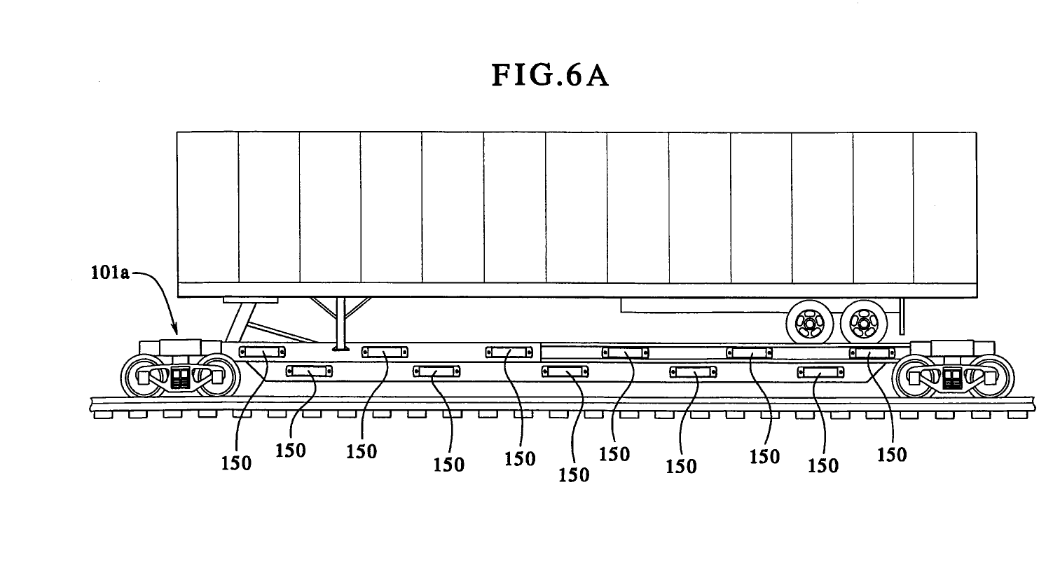

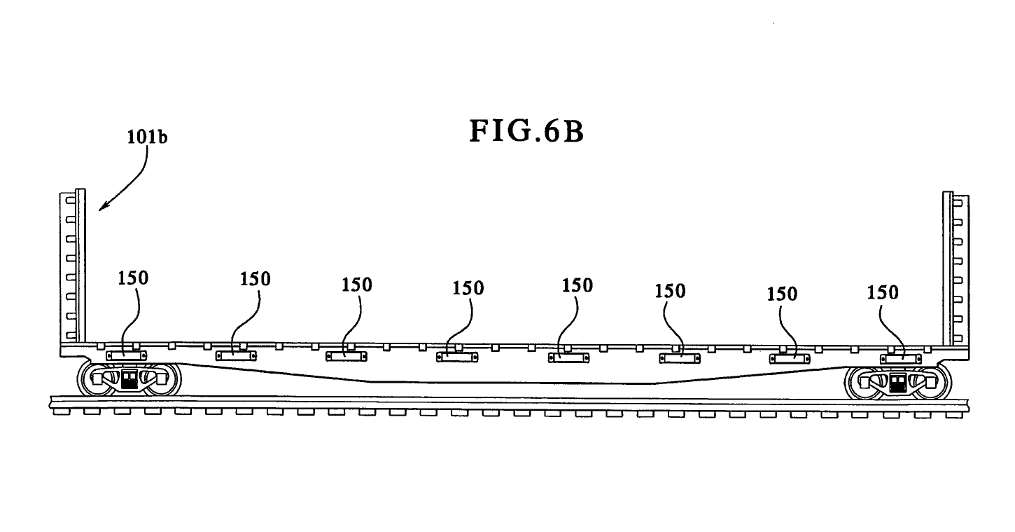

FIGS. 3, 4, and 5 illustrate one embodiment of a freight railroad car reflector or reflector apparatus of the present invention which is generally indicated by numeral 50. The freight railroad car reflector apparatus 50 includes a mounting member or base 52 and a reflector 54 suitably attached to the mounting member or base 52. The mounting member or base 52 includes a reflector supporter 56 and a plurality of mounting sections such as mounting sections 58a, 58b, 58c and 58d connected to the reflector supporter 56. The mounting sections 58a, 58b, 58c and 58d extend transversely from opposing ends of the reflector supporter 56 and transversely from opposing sides of the reflector supporter 56 in this embodiment. The mounting sections 58a, 58b, 58c and 58d respectively define mounting apertures 60a, 60b, 60c and 60d configured to and for facilitating attachment of the reflector apparatus 50 to the freight railroad car, and more particularly in this illustrated embodiment to an autorack railroad car as generally illustrated in FIG. 6 and as further discussed below. It should be appreciated that in this embodiment and the other embodiments disclosed herein, one or more additional mounting members (such as centrally positioned mounting members extending transversely from the reflector support) may be employed to further secure the freight railroad car reflector apparatus to the freight railroad car.

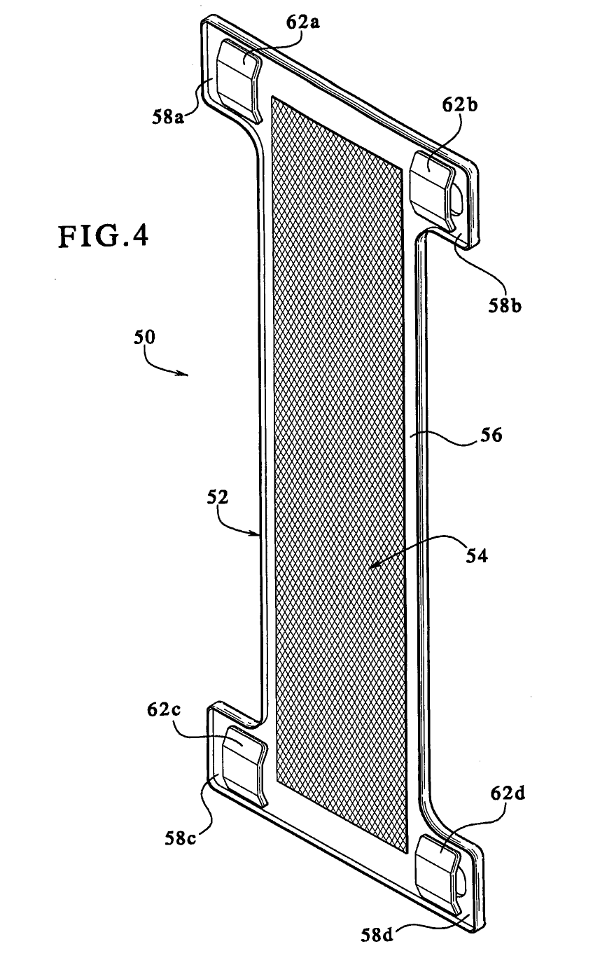

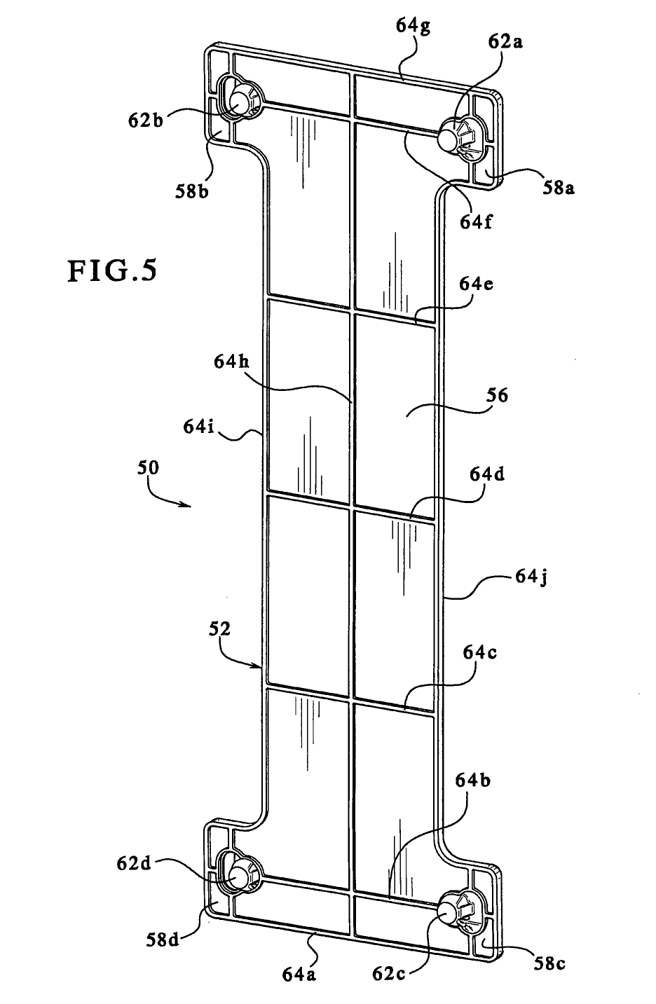

In one embodiment, the reflector apparatus 50 also includes suitable fasteners or attachment mechanisms for attaching the mounting member or base 52 to the freight railroad car such as the fasteners or attachment mechanisms 62a, 62b, 62c and 62d as generally illustrated in FIGS. 4 and 5. The fasteners may be any suitable type of fastener which can or can be used to attach the mounting sections to the autorack railroad car sidewall panel screens. One such type of fastener is described in U.S. Pat. No. 5,239,933. Other suitable types of commercially available fasteners may be employed in accordance with the present invention.

As best illustrated in FIG. 3, each mounting section defines a mounting aperture which is shaped and sized to receive the fastener in at least one position and alternatively in two different positions. In the illustrated embodiment of FIGS. 3, 4, and 5, the mounting apertures 60a, 60b, 60c and 60d are shaped to facilitate attachment of the reflector apparatus in a vertical or substantially vertical position relative to the autorack railroad car or in a horizontal or substantially horizontal position relative to the autorack railroad car. These alternative mounting positions are generally illustrated in FIG. 6. More specifically, each mounting aperture has a first or horizontal diameter sized and shaped to allow for expansion and contraction of the mounting member 52 when the reflector apparatus is vertically mounted, and a second vertical diameter to allow for expansion and contraction of the mounting member 52 when the reflector apparatus is horizontally mounted. The first and second diameters are substantially transverse to each other in the illustrated embodiment.

The reflector apparatus 50 may be made from any suitable material(s). The mounting member or base 52 may be any suitable type of material such as a molded plastic or a stamped metal. The reflector 54 of the reflector apparatus 50 is in one embodiment a suitable adhesive backed reflective tape such as a reflective tape commercially available from 3M, Avery Dennison and Reflexite. These entities sell reflective tape approved by the Federal Railroad Association and labeled FRA-224. Certain requirements for such reflective tape are set forth in the above mentioned regulations. The present invention contemplates that the adhesive backed reflective tape can be placed on the reflector supporter in a controlled environment (such as in a factory or inside a suitable room where the temperature and other conditions are controlled and the reflector support is clean and flat) such that maximum adhesive properties are achieved. This provides a great advantage over directly placing the reflective tape on the freight railroad car in the field or in railroad car repair areas where suitable temperature, climate and conditions are not always possible to achieve the best adhesion and where the freight railroad cars must be cleaned or painted (as described above) prior to such placement. It should also be appreciated that other suitable types of reflective material may be employed in the freight railroad car reflector apparatus of the present invention.

To install the reflector apparatus 50 on an autorack railroad car in accordance with the method of the present invention, the installer simply takes the reflector apparatus and holds it adjacent to the exterior autorack railroad car side wall panel screen in the appropriate position and inserts the fasteners in each of the mounting apertures and through the holes in the side wall panel screen. The autorack railroad car does not have to be cleaned and does not have to be at a certain temperature (such as fifty degrees or above) or in other suitable conditions. This takes a couple of minutes for each side of the autorack railroad car. It should thus be appreciated that each autorack railroad car can be equipped with reflector apparatus (such as in FIG. 6) easily and quickly. The installation can be performed while an autorack railroad car is being loaded or unloaded.

It should also be appreciated that FIGS. 3, 4 and 5 illustrate that the mounting member or base 52 in one embodiment has structural supports such as supports or ribs 64a, 64b, 64c, 64d, 64e, 64f, 64g, 64h, 64i and 64j to provide substantial rigidity to the mounting member or base 52 and the entire reflector apparatus 50. Any suitable structural supports may be employed in the reflector apparatus to provide such rigidity. Additionally, the mounting apertures may have or be defined in part by structural supports. The supports of the reflector apparatus 50 also define an outer raised border, air deflector or air foil around the entire outer edge mounting member 52. This border, air deflector or air foil functions to deflect or redirect wind from engaging the leading edge of the reflector 54. This prevents peeling of the reflector material 54 from the mounting member 52. Because the air deflector or air foil is along all of the edges, the air deflector works to protect the leading edge whether the reflector apparatus 50 is placed in a vertical or horizontal position. This configuration also protects the reflector material regardless of the direction of movement of the freight railroad car. Alternatively, the air deflector can be along less than all of the edges such as along at least one edge, or along opposing edges in this embodiment and the other embodiments disclosed herein.

It should also be appreciated that the reflector supporter of the present invention can be recessed relative to the rest of the mounting member or have a recessed reflector receiving area to protect the edges of the reflector.

In alternative embodiments, the mounting member is substantially flat without the structural supports. This embodiment can be extruded from a suitable plastic and cut in a conventional manner. In certain such embodiments, the mounting apertures can be stamped out of the mounting sections in a conventional manner. It should thus be appreciated that the reflector apparatus of the embodiment of FIGS. 3 to 5 and the other embodiments described below can be alternatively formed or manufactured. Specifically, it should be appreciated that the embodiments disclosed herein may be somewhat altered to be alternatively manufactured such as by an extrusion process. It should also be appreciated that the mounting members can be connected to and extend along the opposing sides of the reflector supporter (and in such case the sides can be considered ends of the reflector supporter as defined herein).

It should further be appreciated that there are many different freight cars and the present invention is configured to be employed for each different type. FIGS. 6A and 6B illustrate two example alternative freight railroad cars 101a and 101b having the railroad car reflectors 150 of one embodiment of the present invention discussed below.

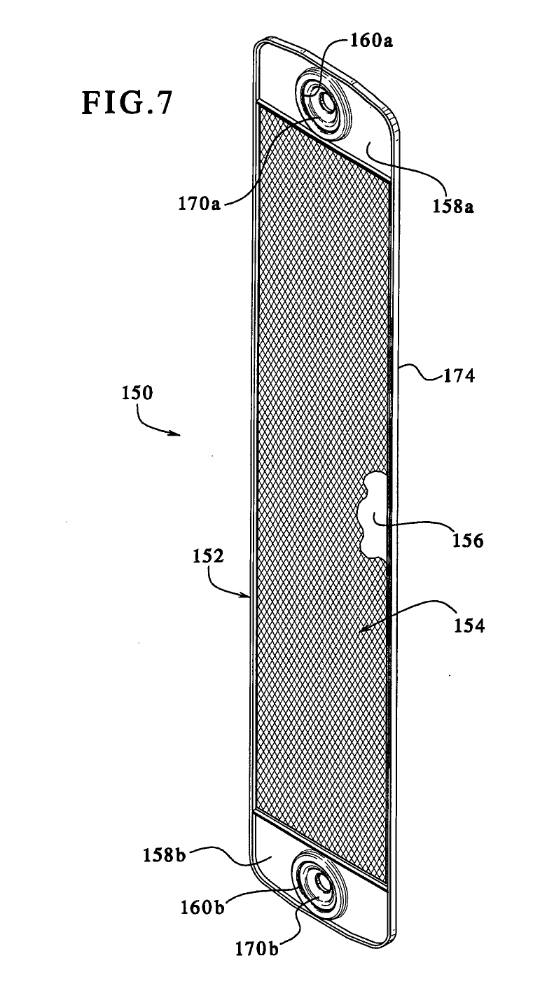

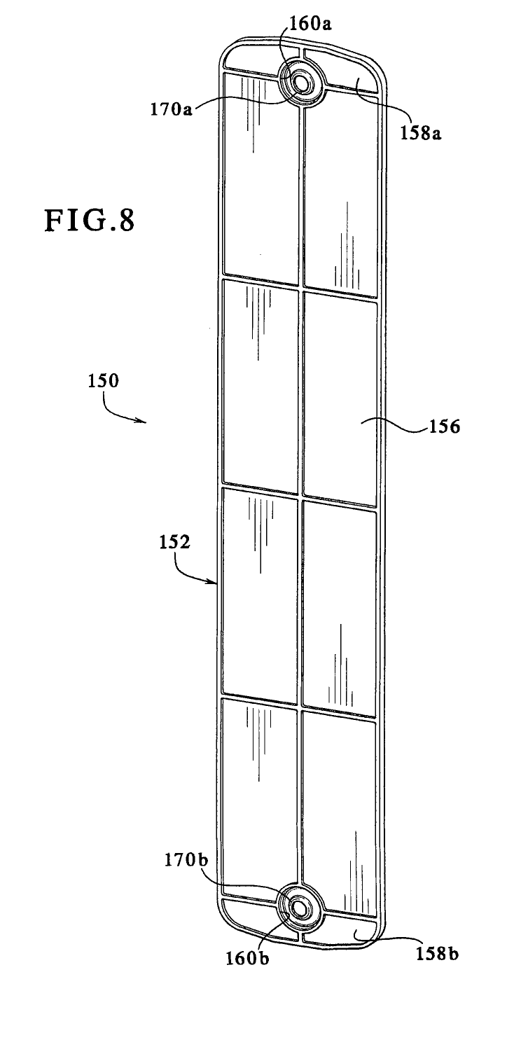

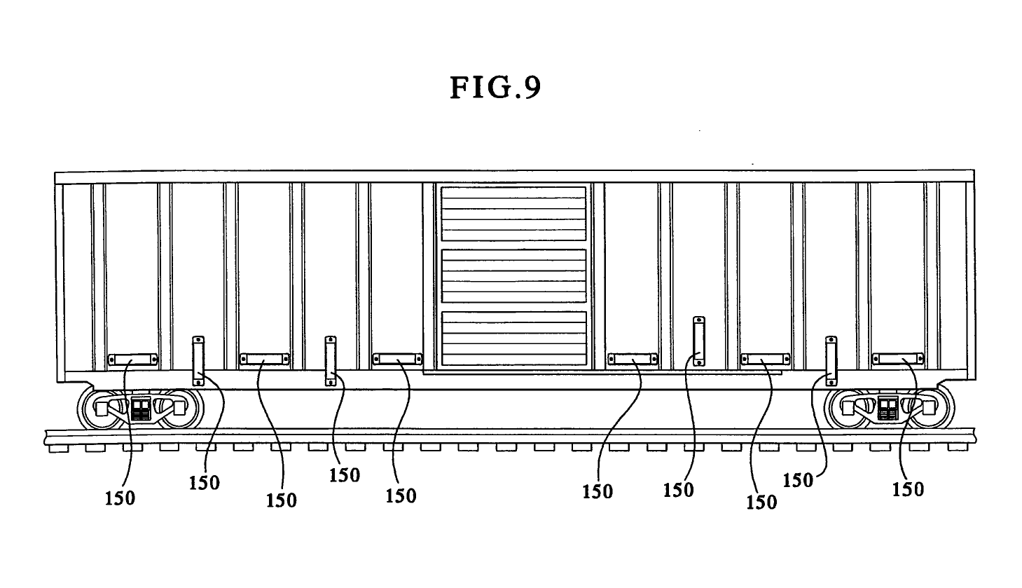

FIGS. 7 and 8 illustrate another embodiment of the reflector apparatus of the present invention which is generally indicated by numeral 150. The freight railroad car reflector apparatus 150 includes a mounting member or base 152 and a reflector 154 suitably attached to the mounting member or base 152. The mounting member or base 152 includes a reflector supporter 156 and mounting sections 158a and 158b connected to the reflector supporter 156. The mounting sections 158a and 158b extend from opposing ends of the reflector supporter 156 in this embodiment. The mounting sections 158a and 158b respectively define mounting apertures 160a and 160b for facilitating attachment of the reflector apparatus 150 to the freight railroad car as generally illustrated in FIG. 9 and as further discussed below.

This embodiment includes attachment mechanisms in the form of circular weld washers 170a and 170b mounted in the mounting apertures 160a and 160b, respectively. The weld washers may be any suitable shape and any suitable material such as steel, aluminum or another metal. The weld washers 170a and 170b are molded into and thus integrally formed with the mounting sections 158a and 158b respectively during the molding process. Each weld washer illustrated has a centrally located aperture for facilitating the welding process. It should be appreciated that the weld washers may be otherwise suitably formed and shaped to facilitate the welding process. This facilitates easy and quick attachment of the reflector apparatus 150 to the freight railroad car in accordance with the method of the present invention. It should also be appreciated that to account for expansion and contraction of the plastic mounting member, the mounting aperture for the in-molded weld washer or other attachment mechanism may be oval or otherwise suitably shaped. In one such embodiment, the weld washer is maintained in the mounting aperture by the configuration of the mounting section in a movable or free floating manner to account for expansion and contraction.

More specifically, to install the reflector apparatus 150 on freight railroad car, the installer simply takes the reflector apparatus 150 and holds it adjacent to the freight railroad car exterior side wall in the appropriate position and welds each weld washer to the side wall. Because the weld washers 170a and 170b are integrally formed or molded in the mounting sections 158a and 158b respectively, the installer does not need to separately hold the reflector apparatus and weld washers. This facilitates easy and quick attachment of the reflective material to the freight railroad car in accordance with the method of the present invention. Additionally, the freight railroad car does not have to be cleaned and does not have to be at a certain temperature. While the welding process may take a couple of minutes for each reflector apparatus, this process is significantly shorter than the current cleaning processes mentioned above. It should thus be appreciated that each freight railroad car can be equipped with the reflector apparatus much easier and quicker than directly applying reflective tape to the freight railroad car. The welding also prevents the freight railroad car reflector from being easily removed from the freight railroad car (i.e., the welding forms a bond between the railroad car reflector and the freight car.)

FIG. 9 illustrates that the reflector apparatus 150 can be placed in a vertical or substantially vertical position relative to the freight railroad car, or in a horizontal or substantially horizontal position relative to the freight railroad car.

The reflector apparatus 150 may be made from any suitable material(s). The mounting member or base 152 may be any suitable type of material such as a molded plastic or a stamped metal. The reflector 154 of the reflector apparatus 150 is in one embodiment a suitable adhesive backed reflective tape such as the reflective tape commercially available as mentioned above. The adhesive backed reflective tape can be placed on the reflector supporter in a controlled environment, as mentioned above, such that maximum adhesive properties are achieved. This provides a great advantage over directly placing the reflective tape on the freight railroad car in the field or in railroad car repair areas where a suitable temperature, climate and other conditions are not always possible to achieve the best adhesion and where the freight railroad cars must be cleaned or painted (as described above) prior to such placement. It should also be appreciated that other suitable types of reflective material may be employed in the freight railroad car reflector apparatus of the present invention.

It should also be appreciated that FIGS. 7 and 8 illustrate that the mounting member or base 152 may have structural supports to provide substantial rigidity to the mounting member or base 152 and the entire reflector apparatus 150. Any suitable structural supports may be employed in the reflector apparatus to provide such rigidity. The supports of the reflector apparatus 150 also define an outer raised border, air deflector or air foil 174 around the entire mounting member 152. This border, air deflector or air foil functions to deflect or redirect wind from engaging the leading edge of the reflector 154. This prevents peeling of the reflector from the mounting member 152. Because the air deflector or air foil is along all of the edges, the air deflector works to protect the leading edge whether the reflector apparatus 150 is placed in a vertical or horizontal position. The air deflector may be along less than all the edges for this embodiment and all of the embodiments disclosed herein as discussed above. This embodiment also provides a recessed reflector receipt area, as can the other various embodiments disclosed herein.

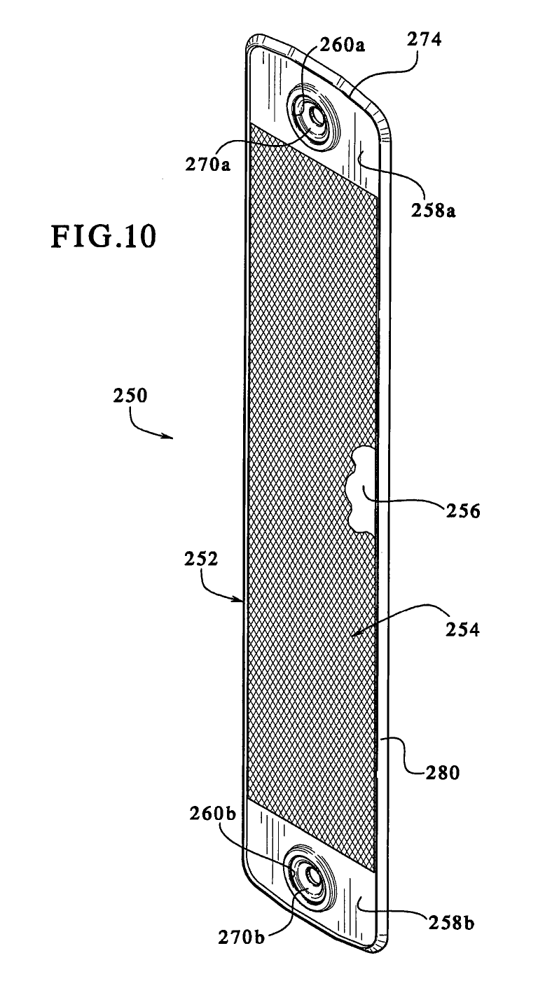

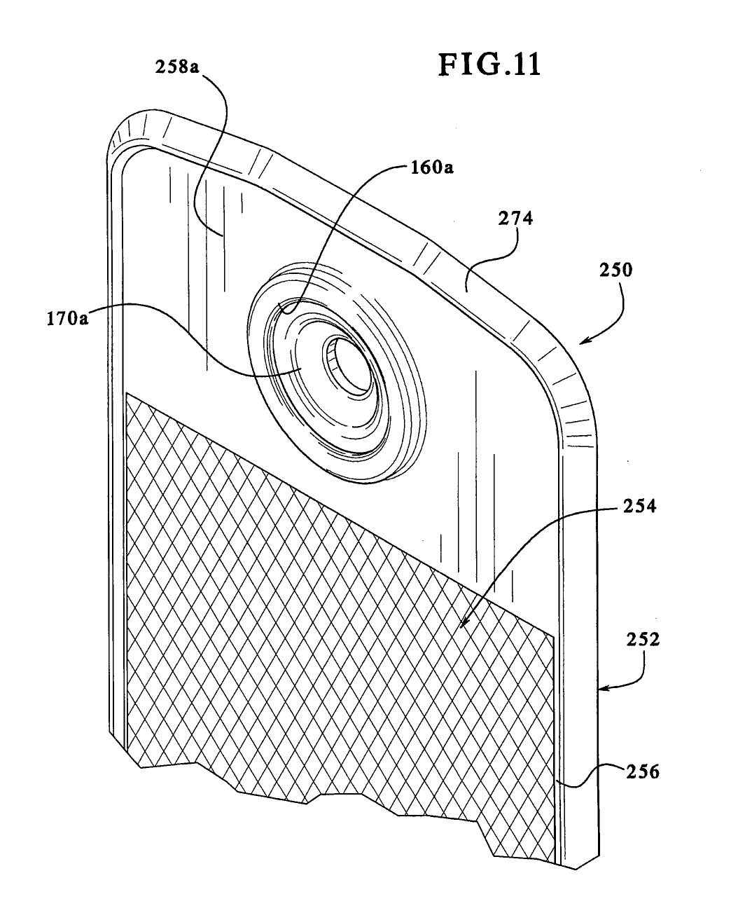

FIGS. 10 and 11 illustrate another embodiment of the reflector apparatus of the present invention which is generally indicated by numeral 250. The freight railroad car reflector apparatus 250 includes a mounting member or base 252 and a reflective material or reflector 254 attached to the mounting member or base 252. The mounting member or base 252 includes a reflector supporter 256 and mounting sections 258a and 258b connected to the reflector supporter 256. The mounting sections 258a and 258b extend transversely from opposing ends of the reflector supporter 256 in this embodiment. The mounting sections 258a and 258b respectively define mounting apertures 260a and 260b for facilitating attachment of the reflector apparatus 250 to the freight railroad car. The reflector apparatus 250 includes steel circular weld washers 270a and 270b molded in or integrally maintained in the mounting sections 258a and 258b, respectively, as best illustrated in FIG. 11.

The reflector apparatus 250 may be made from any suitable material(s). The mounting member or base may be any suitable type of material such as a molded plastic or a stamped metal. The reflector 254 of the reflector apparatus 250 is in one embodiment a suitable adhesive backed reflective tape such as the reflective tape commercially available as mentioned above. It should also be appreciated that other suitable types of reflective material may be employed in the freight railroad car reflector apparatus of the present invention.

The freight railroad car reflector apparatus 250 is different from the freight railroad car reflector apparatus 150 at least in the shape of the outer border, air deflector or air foil 274. This alternative shape also prevents peeling of the reflector material from the mounting member 252. Because the air deflector or air foil is along all of the edges, the air deflector works to protect the leading edge whether the reflector apparatus 250 is placed in a vertical or horizontal position. It should also be appreciated that the mounting member or base 252 may have other structural supports to provide substantial rigidity to the mounting member or base 252 and the entire reflector apparatus 250. It should be appreciated that any suitable structural supports may be employed in the reflector apparatus to provide such rigidity.

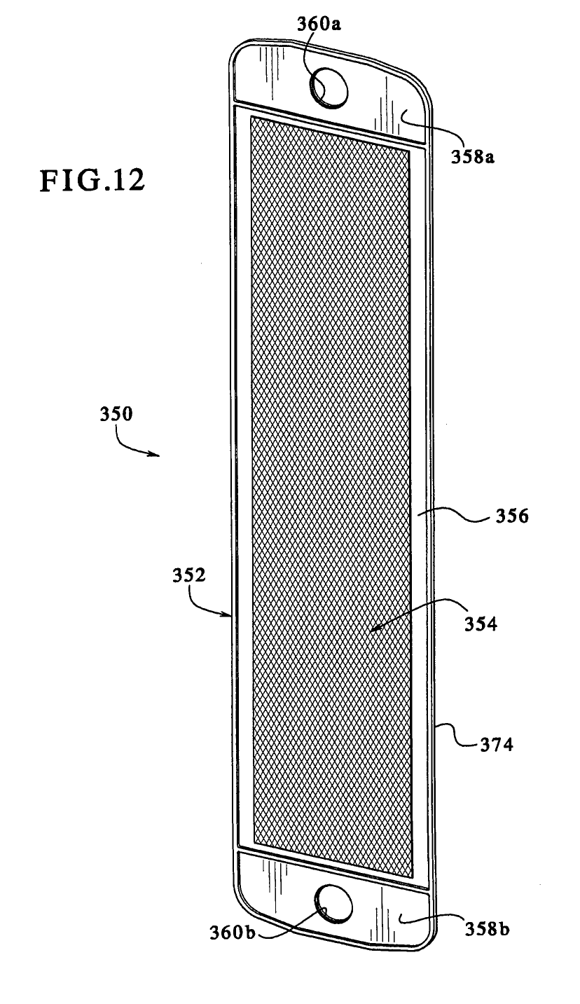

FIG. 12 illustrates another embodiment of the reflector apparatus of the present invention which is generally indicated by numeral 350. The freight railroad car reflector apparatus 350 includes a mounting member or base 352 and a reflective material or reflector 354 attached to the mounting member or base 352. The mounting member or base 352 includes a reflector supporter 356 and mounting sections 358a and 358b connected to and extending from opposite ends of the reflector supporter 356. The mounting sections 358a and 358b respectively define mounting apertures 360a and 360b for facilitating attachment of the reflector apparatus 350 to the freight railroad car.

The freight railroad car reflector apparatus 350 is different from the freight railroad car reflector apparatus 150 in that fasteners or attachment mechanisms such as the weld washers are not molded into or integrally formed with the mounting sections 358a and 358b. To install the reflector apparatus 350 on freight railroad car in accordance with one embodiment of the present invention, the installer takes the reflector apparatus 350 and holds it adjacent to the freight railroad car exterior side wall or frame in the appropriate position, positions the attachment mechanism such as a weld washer in one of the mounting apertures and welds the weld washer to the freight railroad car. The installer repeats this process for each mounting aperture. It should be appreciated that in this embodiment and in the other embodiments discussed herein, the number, configuration and arrangement of mounting apertures may vary.

The reflector apparatus 350 may be made from any suitable material(s). The mounting member or base may be any suitable type of material such as a molded plastic or a stamped metal. The reflector 354 of the reflector apparatus 350 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention.

It should also be appreciated that FIG. 12 illustrates that the mounting member or base 352 may have structural supports to provide substantial rigidity to the mounting member or base 352 and the entire reflector apparatus 350. Any suitable structural supports may be employed in the reflector apparatus to provide such rigidity. The supports of the reflector apparatus 350 also define an outer raised border, air deflector or air foil 374 around the entire mounting member 352. This border, air deflector or air foil 374 functions to deflect or redirect wind from engaging the leading edge of the reflector 354. This prevents peeling of the reflector material from the mounting member 352. Because the air deflector or air foil is along all of the edges, the air deflector works to protect the leading edge whether the reflector apparatus 350 is placed in a vertical or horizontal position.

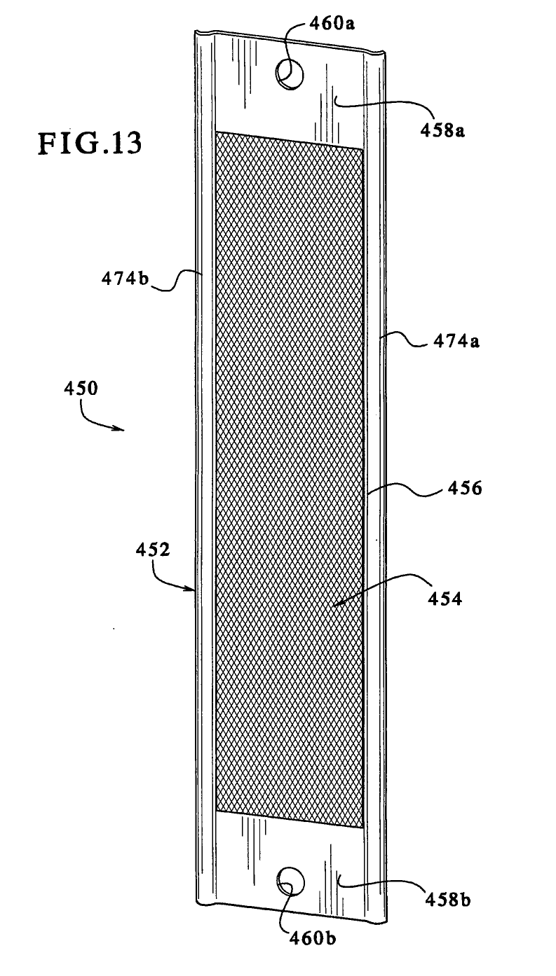

FIG. 13 illustrates another embodiment of the reflector apparatus of the present invention which is generally indicated by numeral 450. The freight railroad car reflector apparatus 450 includes a mounting member or base 452 and a reflector 454 attached to the mounting member or base 452. The mounting member or base 452 includes a reflector supporter 456 and mounting sections 458a and 458b connected to the reflector supporter 456. The mounting sections 458a and 458b respectively define mounting apertures 460a and 460b for facilitating attachment of the reflector apparatus 450 to the freight railroad car.

The freight railroad car reflector apparatus 450 is different from the freight railroad car reflector apparatus 150 in that the weld washers are not molded into the mounting sections 458a and 458b. The shapes of the mounting sections are also different for the reason discussed below.

The reflector apparatus 450 may be made from any suitable material. The mounting member may be any suitable type of material such as a molded plastic or a stamped metal. In one embodiment, the mounting member 452 is specifically configured to be extruded. The mounting apertures 460a and 460b are stamped in the mounting sections 458a and 458b. In the extrusion process, several mounting members are formed in a single extrusion and are then cut or separated. This separation process forms the straight edge along each end of the mounting member. The structure illustrated has the air deflectors/structural supports 474a and 474b along opposing sides of the mounting member as discussed below. It should be appreciated that a different embodiment may be extruded in a transverse direction to provide the air deflectors/structural supports at the ends of the mounting members.

The reflector 454 of the reflector apparatus 450 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention.

It should be appreciated that FIG. 13 illustrates the reflector apparatus 450 define air deflectors or air foils 474a and 474b on opposite sides of the mounting member 452. These air deflectors or air foils functions to deflect or redirect wind from engaging the leading edge of the reflector 454 when the reflector is mounted in a vertical or substantially vertical position. This prevents peeling of the reflector from the mounting member 452. In this illustrated embodiment, the air foils or air deflector are semi-circular; however, it should be appreciated that they may be any suitable shape. It should also be appreciated as mentioned above that the air deflectors may be positioned such that the reflector apparatus can be positioned horizontally.

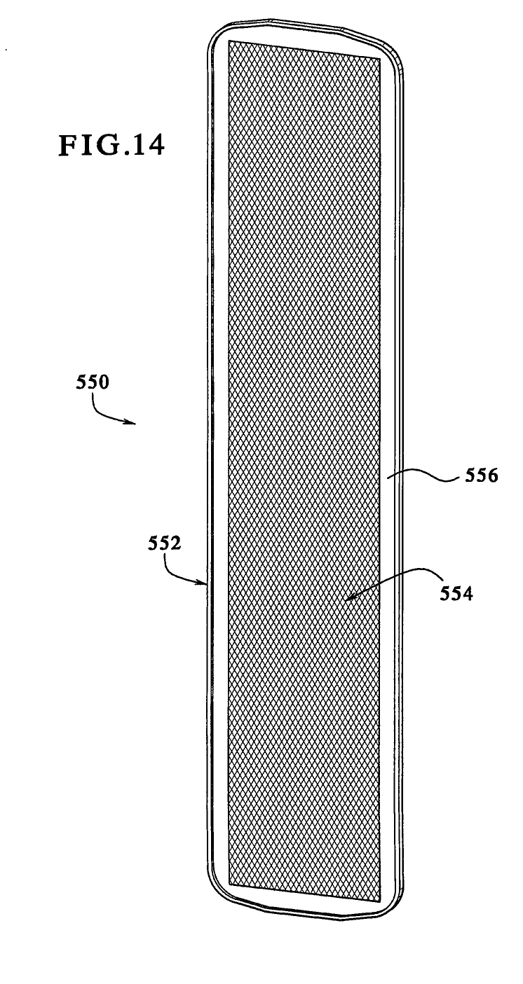

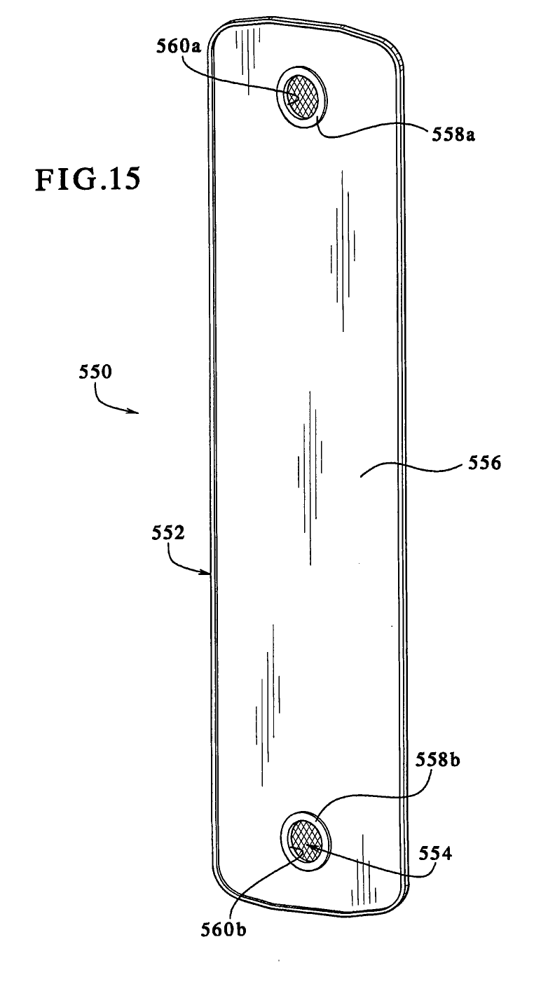

FIGS. 14 and 15 illustrate another embodiment of the reflector apparatus of the present invention which is generally indicated by numeral 550. The freight railroad car reflector apparatus 550 includes a mounting member or base 552 and a reflector 554 attached to the mounting member or base 552. The mounting member or base 552 includes a reflector supporter 556 and mounting sections 558a and 558b connected to the back of and extending from the reflector supporter 556 as best illustrated in FIG. 15.

The mounting sections 558a and 558b respectively define mounting apertures 560a and 560b for facilitating attachment of the reflector apparatus 550 to the freight railroad car as discussed below.

The reflector apparatus 550 may be made from any suitable material(s). The mounting member or base may be any suitable type of material such as a molded plastic or a stamped metal. The reflector 554 of the reflector apparatus 550 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention.

This reflector apparatus is provided in three separate parts for installation. More particularly, the reflector is not attached to the reflector supporter 556 of the mounting member 552 until installation. The installer uses the weld washers to attach the mounting member 552 to the freight railroad car and then attaches the reflector 554 to the reflector supporter 556. The reflector 556 thus covers the weld washers.

It should also be appreciated that FIGS. 14 and 15 illustrate that the mounting member or base 552 may have structural supports to provide substantial rigidity to the mounting member or base 552 and the entire reflector apparatus 550. Any suitable structural supports may be employed in the reflector apparatus to provide such rigidity. The supports of the reflector apparatus 550 also define an outer raised border, air deflector or air foil around the entire mounting member 552. This border, air deflector or air foil functions to deflect or redirect wind from engaging the leading edge of the reflector 554. This prevents peeling of the reflector from the mounting member 552. Because the air deflector or air foil is along all of the edges, the air deflector works to protect the leading edge whether the reflector apparatus 550 is placed in a vertical or horizontal position.

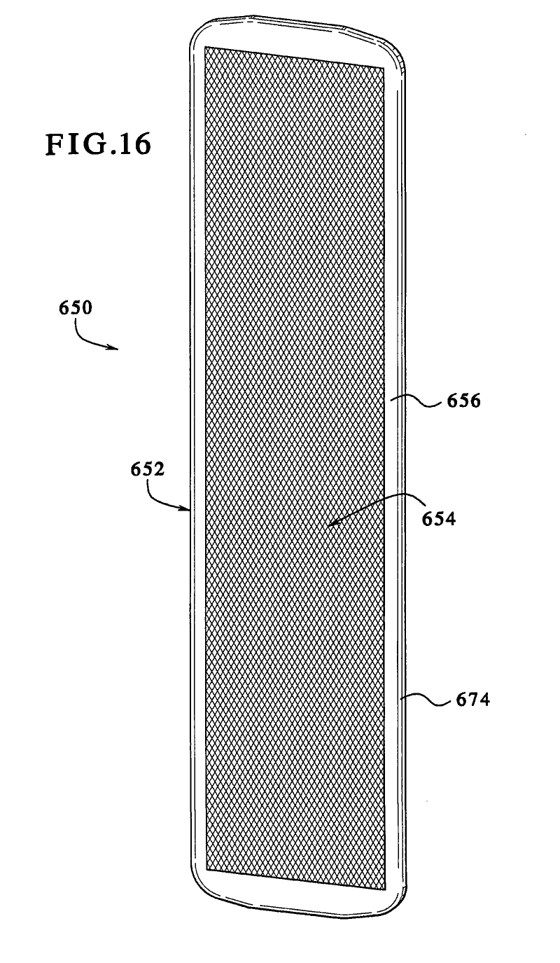

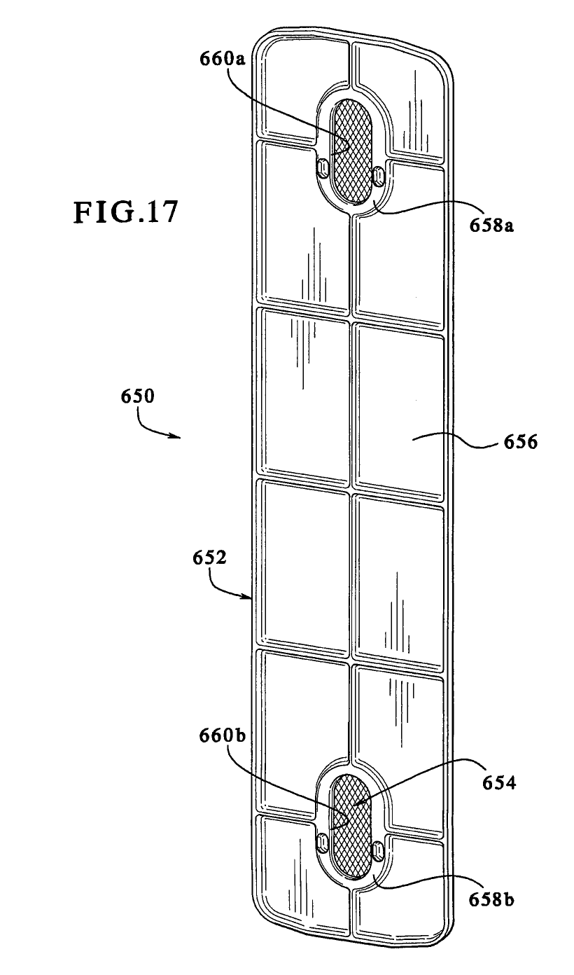

FIGS. 16 and 17 illustrate another embodiment of the reflector apparatus of the present invention which is generally indicated by numeral 650. The freight railroad car reflector apparatus 650 includes a mounting member or base 652 and a reflector 654 attached to the mounting member or base 652. The mounting member or base 652 includes a reflector supporter 656 and mounting sections 658a and 658b connected to the reflector supporter 656 as best illustrated in FIG. 17.

The mounting sections 658a and 658b respectively define oval mounting apertures 660a and 660b for facilitating attachment of the reflector apparatus 650 to the freight railroad car as discussed below. It should be appreciated that in this embodiment and the other embodiments disclosed herein, the shape of the apertures may vary.

The reflector apparatus 650 may be made from any suitable material(s). The mounting member or base may be any suitable type of material such as a molded plastic or a stamped metal. The reflector 654 of the reflector apparatus 650 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention.

Similar to the embodiment of FIGS. 14 and 15, this reflector apparatus 650 is provided in three separate parts for installation. The reflector 654 is not attached to the reflector supporter 656 of the mounting member 652 until installation. The installer uses the weld washers to attach the mounting member 652 to the freight railroad car and then attaches the reflector 654 to the reflector supporter 656. More particularly, the mounting sections 658a and 658b respectively have mounting apertures and weld washer holders or tabs which allow an installer to place the weld washers in the apertures, allow the weld washer to slide downwardly and be held or maintained by the tabs during the welding process. The reflector 656 thus covers the weld washers. In an alternative embodiment, the present method and apparatus contemplates that the weld washers or other suitable attachment mechanisms would be preinstalled in the mounting sections.

It should also be appreciated that FIGS. 16 and 17 illustrate that the mounting member or base 652 may have structural supports to provide substantial rigidity to the mounting member or base 652 and the entire reflector apparatus 650. Any suitable structural supports may be employed in the reflector apparatus to provide such rigidity. The supports of the reflector apparatus 650 also define an outer raised border, air deflector or air foil 674 around the entire or portions of mounting member 652. This border, air deflector or air foil functions to deflect or redirect wind from engaging the leading edge of the reflector 654. This prevents peeling of the reflector from the mounting member 652. Because in one embodiment the air deflector or air foil is along all of the edges, the air deflector works to protect the leading edge whether the reflector apparatus 650 is placed in a vertical or horizontal position.

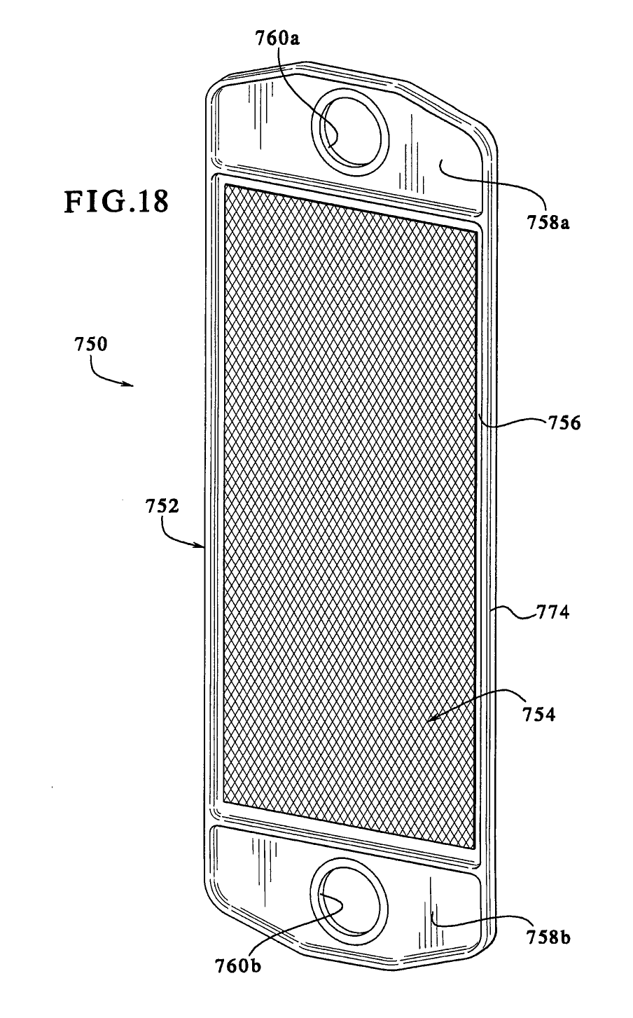

FIG. 18 illustrates another embodiment of the reflector apparatus of the present invention which is generally indicated by numeral 750. The freight railroad car reflector apparatus 750 includes a mounting member or base 752 and a reflector 754 attached to the mounting member or base 752. The mounting member or base 752 includes a reflector supporter 756 and mounting sections 758a and 758b connected to the reflector supporter 756. The mounting member or base 752 includes a reflector supporter 756 and mounting sections 758a and 758b connected to the reflector supporter 756.

The mounting sections 758a and 758b respectively define mounting apertures 760a and 760b for facilitating attachment of the reflector apparatus 750 to the freight railroad car. The reflector support 756 in this embodiment has a recessed area for receiving the reflector 754.

The reflector apparatus 750 may be made from any suitable material(s). The mounting member or base may be any suitable type of material such as a molded plastic or a stamped metal. The reflector 754 of the reflector apparatus 750 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention.

It should also be appreciated that FIG. 18 illustrates that the mounting member or base 752 may have structural supports to provide substantial rigidity to the mounting member or base 752 and the entire reflector apparatus 750. Any suitable structural supports may be employed in the reflector apparatus to provide such rigidity. The supports of the reflector apparatus 750 also defines an outer raised border, air deflector or air foil 774 around the entire mounting member 752. This border, air deflector or air foil functions to deflect or redirect wind from engaging the leading edge of the reflector 754. This prevents peeling of the reflector from the mounting member 752. Because the air deflector or air foil is along all of the edges, the air deflector works to protect the leading edge whether the reflector apparatus 750 is placed in a vertical or horizontal position.

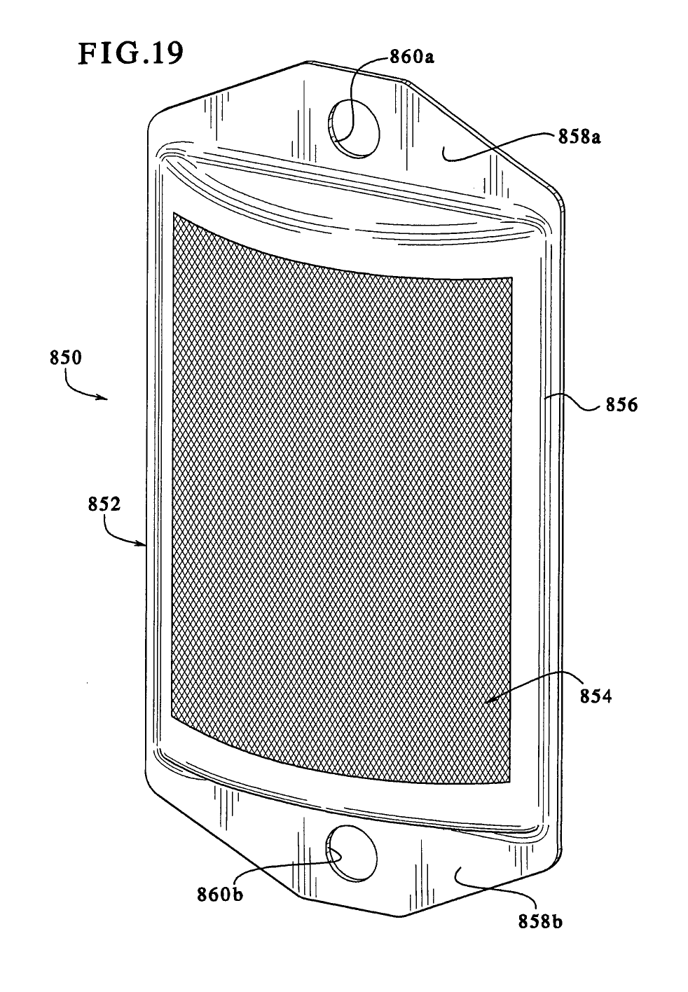

FIGS. 19, 20 and 21 illustrate additional alternative embodiments of the present invention. Generally, they illustrate that the reflector support can be formed extending from the mounting member to provide reflection at greater angles. This provides greater ability to reflect light.

More specifically, FIG. 19 illustrates another embodiment of the reflector apparatus of the present invention which is generally indicated by numeral 850. The freight railroad car reflector apparatus 850 includes a mounting member or base 852 and a reflector 854 attached to the mounting member or base 852. The mounting member or base 852 includes a curved or semi-circular reflector supporter 856 and mounting sections 858a and 858b connected to the reflector supporter 856. The mounting member or base 852 includes a reflector supporter 856 and mounting sections 858a and 858b connected to the reflector supporter 856. The mounting sections 858a and 858b respectively define mounting apertures 860a and 860b for facilitating attachment of the reflector apparatus 850 to the freight railroad car.

The reflector apparatus 850 may be made from any suitable material(s). The mounting member or base may be any suitable type of material such as a molded plastic or a stamped metal. The reflector 854 of the reflector apparatus 850 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention. Specifically, in this embodiment, the reflector may be a plastic reflector supported by the reflector supporter.

It should also be appreciated that FIG. 19 illustrates that the mounting member or base 852 may have structural supports to provide substantial rigidity to the mounting member or base 852, the reflector supporter and the entire reflector apparatus 850. Any suitable structural supports may be employed in the reflector apparatus to provide such rigidity. It should also be appreciated that the reflector can be mounted with the edges protected by the reflector supporter to prevent peeling of the reflector from the mounting member 852.

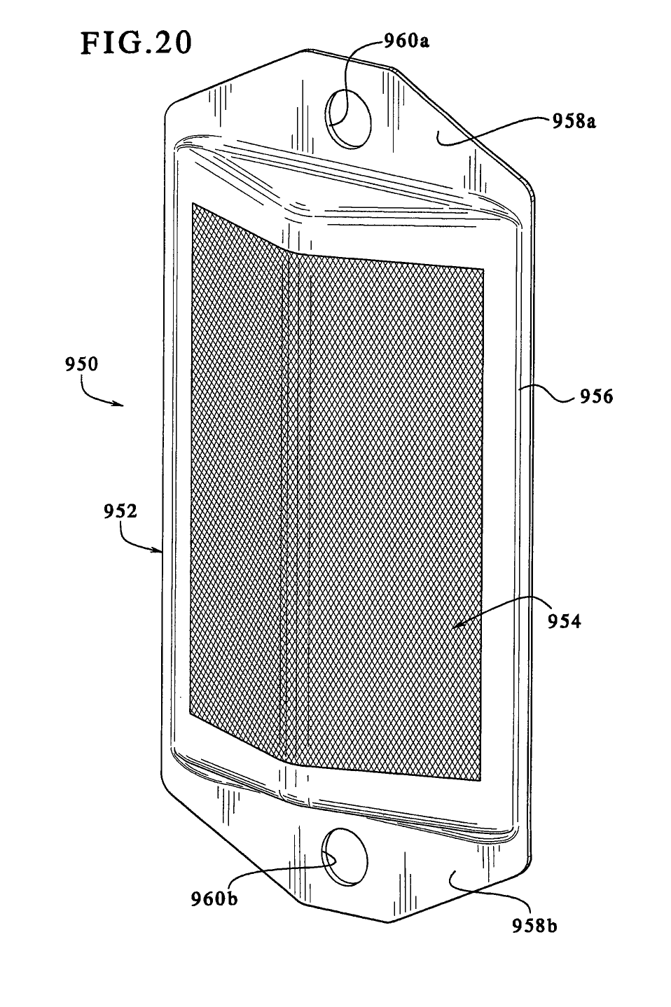

FIG. 20 illustrates another embodiment of the reflector apparatus of the present invention which is generally indicated by numeral 950. The freight railroad car reflector apparatus 950 includes a mounting member or base 952 and a reflector 954 attached to the mounting member or base 952. The mounting member or base 952 includes a somewhat triangular reflector supporter 956 and mounting sections 958a and 958b connected to the reflector supporter 956. The mounting member or base 952 includes a reflector supporter 956 and mounting sections 958a and 958b connected to the reflector supporter 956.

The mounting sections 958a and 958b respectively define mounting apertures 960a and 960b for facilitating attachment of the reflector apparatus 950 to the freight railroad car.

The reflector apparatus 950 may be made from any suitable material(s). The mounting member or base may be any suitable type of material such as a molded plastic or a stamped metal. The reflector 954 of the reflector apparatus 950 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention. Specifically, in this embodiment, the reflector may be a plastic reflector supported by the reflector supporter.

It should also be appreciated that FIG. 20 illustrates that the mounting member or base 952 may have structural supports to provide substantial rigidity to the mounting member or base 952, the reflector supporter and the entire reflector apparatus 950. Any suitable structural supports may be employed in the reflector apparatus to provide such rigidity. It should also be appreciated that the reflector can be mounted with the edges protected by the reflector supporter to prevent peeling of the reflector from the mounting member 952.

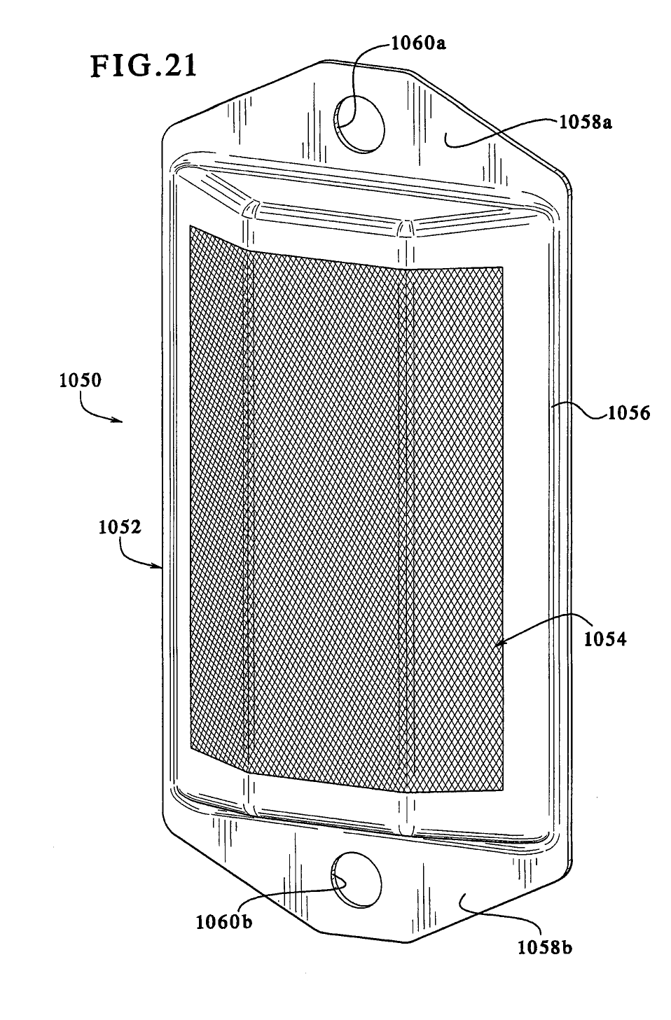

FIG. 21 illustrates another embodiment of the reflector apparatus of the present invention which is generally indicated by numeral 1050. The freight railroad car reflector apparatus 1050 includes a mounting member or base 1052 and a reflector 1054 attached to the mounting member or base 1052. The mounting member or base 1052 includes a somewhat trapezoidal reflector supporter 1056 and mounting sections 1058a and 1058b connected to the reflector supporter 1056. The mounting member or base 1052 includes a reflector supporter 1056 and mounting sections 1058a and 1058b connected to the reflector supporter 1056. The mounting sections 1058a and 1058b respectively define mounting apertures 1060a and 1060b for facilitating attachment of the reflector apparatus 1050 to the freight railroad car.

The reflector apparatus 1050 may be made from any suitable material(s). The mounting member or base may be any suitable type of material such as a molded plastic or a stamped metal. The reflector 1054 of the reflector apparatus 1050 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention. Specifically, in this embodiment, the reflector may be a plastic reflector supported by the reflector supporter.

It should also be appreciated that FIG. 21 illustrates that the mounting member or base 1052 may have structural supports to provide substantial rigidity to the mounting member or base 1052, the reflector supporter and the entire reflector apparatus 1050. It should be appreciated that any suitable structural supports may be employed in the reflector apparatus to provide such rigidity. It should also be appreciated that the reflector can be mounted with the edges protected by the reflector supporter to prevent peeling of the reflector from the mounting member 1052.

It should be appreciated that in any of the embodiments of the present invention, the reflector apparatus can include a cover mounted over the reflector or the reflector and mounting member to protect the surface of the reflector from scratching or other damage. In one such embodiment, the cover is a clear plastic sheet. In another embodiment the cover includes a clear material molded around the reflector. Other suitable covers may be employed in the reflector apparatus.

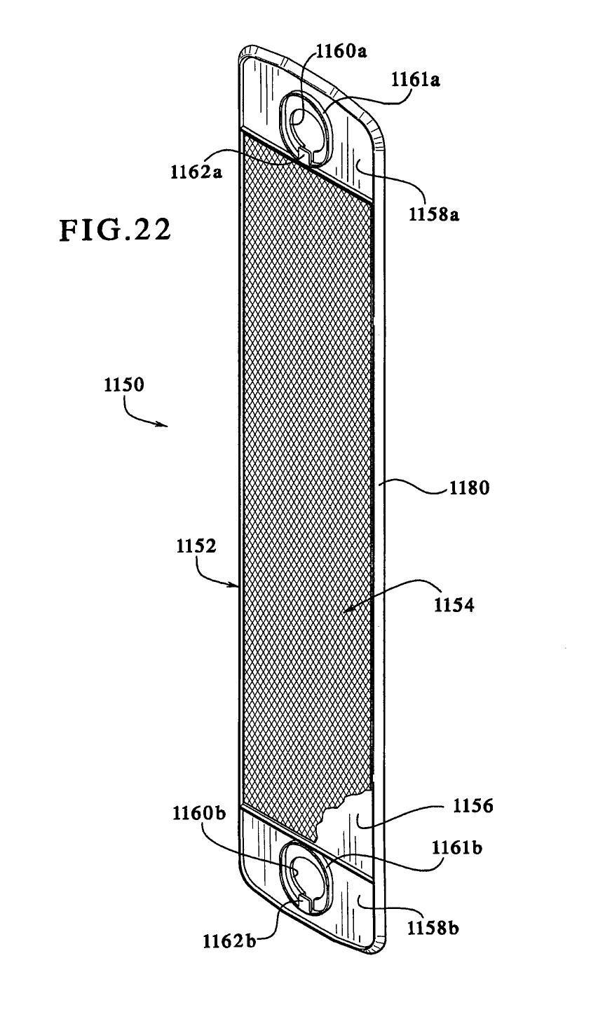

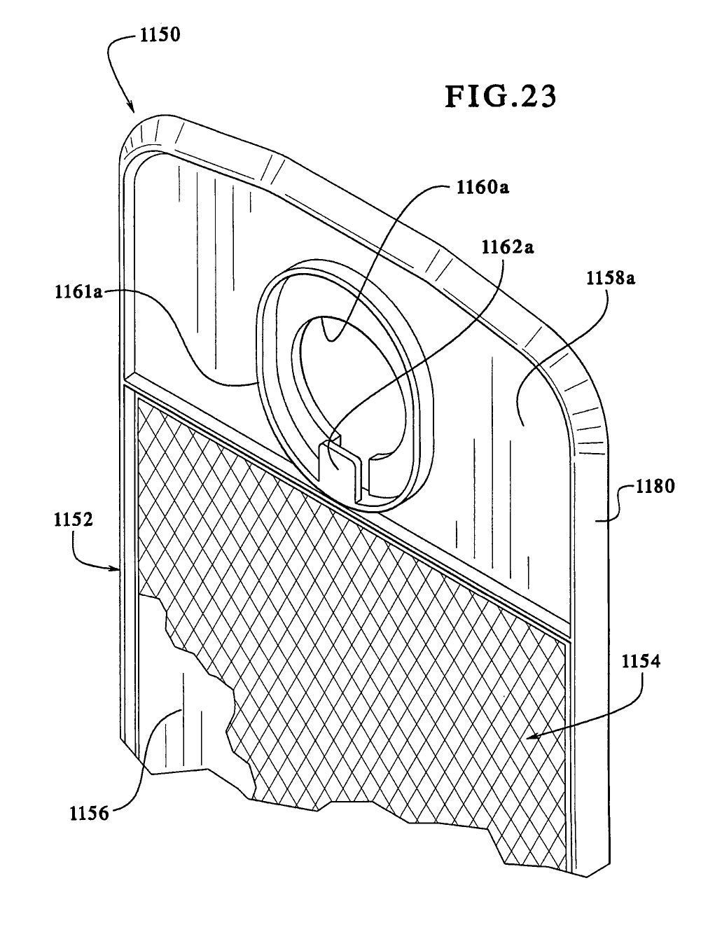

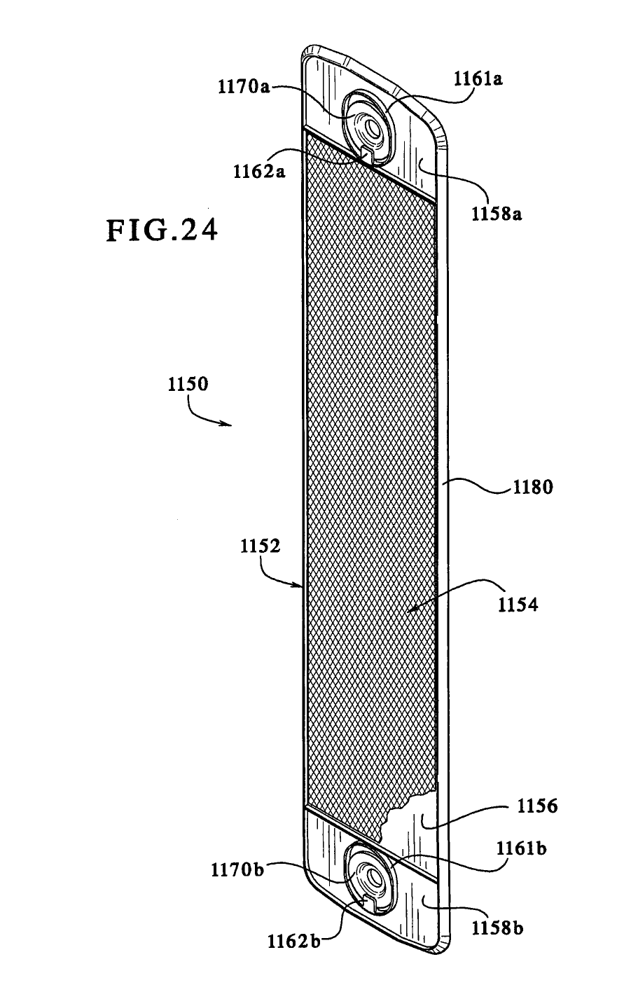

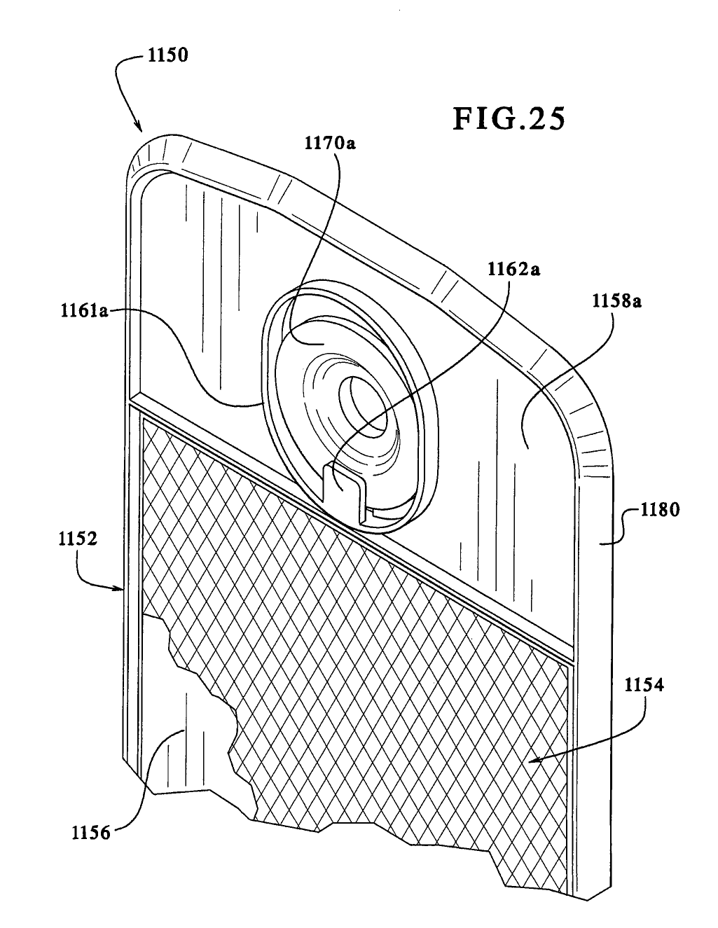

FIGS. 22, 23, 24 and 25 illustrate another embodiment of the reflector apparatus of the present invention which is generally indicated by numeral 1150. The freight railroad car reflector apparatus 1150 includes a mounting member or base 1152 and a reflector 1154 attached to the mounting member or base 1152. The mounting member or base 1152 includes a reflector supporter 1156 and mounting sections 1158a and 1158b connected to and extending from opposing ends of the reflector supporter 1156. The reflector support 1156 in this embodiment has a recessed area for receiving the reflector 1154.

The mounting sections 1158a and 1158b respectively define mounting apertures 1160a and 1160b configured for facilitating attachment of the reflector apparatus 1150 to the freight railroad car. The mounting apertures 1160a and 1160b are suitably sized to receive a portion of weld washers 1170a and 1170b. A portion of each of the weld washers 1170a and 1170b respectively extend beyond the mounting apertures 1160a and 1160b to provide a sufficient purchase area to enable the weld washers to maintain the mounting sections 1158a and 1158b (and the entire reflector apparatus 1150) to the freight railroad car when the weld washers are welded to the freight railroad car.

The mounting sections 1158a and 1158b have weld washer guides 1161a and 1161b and weld washer holders or tabs 1162a and 1162b which allow an installer to place the weld washers 1170a and 1170b in the mounting apertures 1160a and 1160b, and which removably hold or maintain the weld washers, to prevent the weld washers 1170a and 1170b from falling out of the mounting apertures prior to or during the welding process. The guides 1161a and 1161b and weld washer holders or tabs 1162a and 1162b thus coact to maintain the weld washers 1170a and 1170b in position for welding. In one embodiment as illustrated, the weld washer guides 1161a and 1161b respectively extend outwardly or transversely from the exterior surface of the mounting sections 1158a and 1158b surrounding the mounting apertures, and the holders or tabs 1162a and 1162b respectively extend from the guides 1161a and 1161b substantially parallel to the mounting apertures. This configuration allows the guide and holder to maintain the weld washer in the mounting aperture. After the weld washers are welded to the freight railroad car, this configuration enables the reflector apparatus to slide back and forth within the area defined by the guide to allow for expansion and contraction.

The reflector apparatus 1150 can be in provided in three separate parts for installation (i.e., the reflector apparatus and the two weld washers removed from the mounting sections) in accordance with the method of the present invention. The installer inserts the weld washers 1170a and 1170b into the apertures of the mounting members 1158a and 1158b and welds them to the freight railroad car in accordance with the method of the present invention.

It should also be appreciated that the mounting member or base 1152 may have structural supports to provide substantial rigidity to the mounting member or base 1152 and the entire reflector apparatus 1150. Any suitable structural supports may be employed in the reflector apparatus to provide such rigidity. The supports of the reflector apparatus 1150 also define an outer raised border, air deflector or air foil 1180. In one embodiment, because the air deflector or air foil is along all of the edges, the air deflector works to protect the leading edge whether the reflector apparatus 1150 is placed in a vertical or horizontal position. This border, air deflector or air foil functions to deflect or redirect wind from engaging the leading edge of the reflector 1154. This prevents peeling of the reflector material from the mounting member 1152.

The reflector apparatus 1150 may be made from any suitable material(s). The mounting member or base may be any suitable type of material such as a molded plastic or a stamped metal. The reflector 1154 of the reflector apparatus 1150 is in one embodiment a suitable adhesive backed reflective tape such as the reflective tape commercially available as mentioned above. It should also be appreciated that other suitable types of reflective material or reflectors may be employed in the freight railroad car reflector apparatus of the present invention.

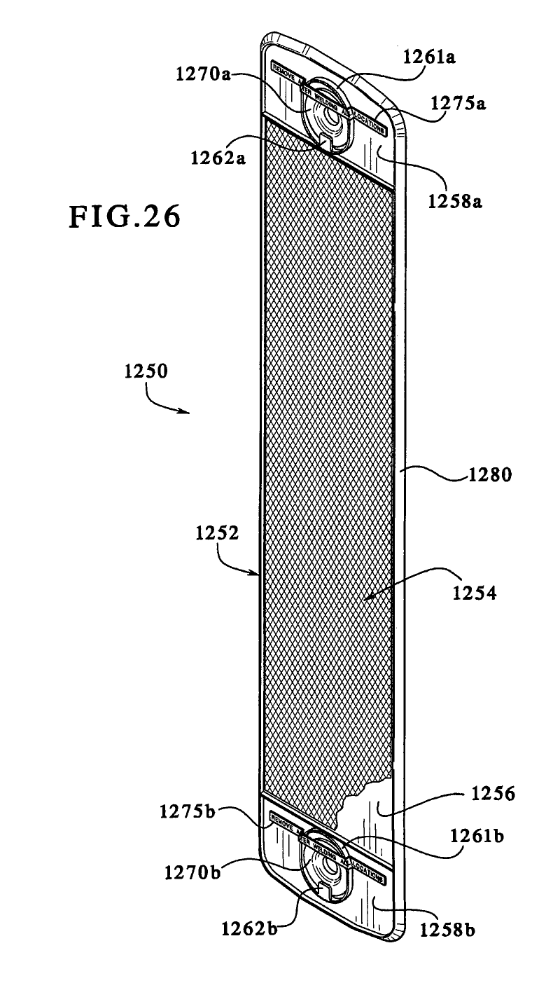

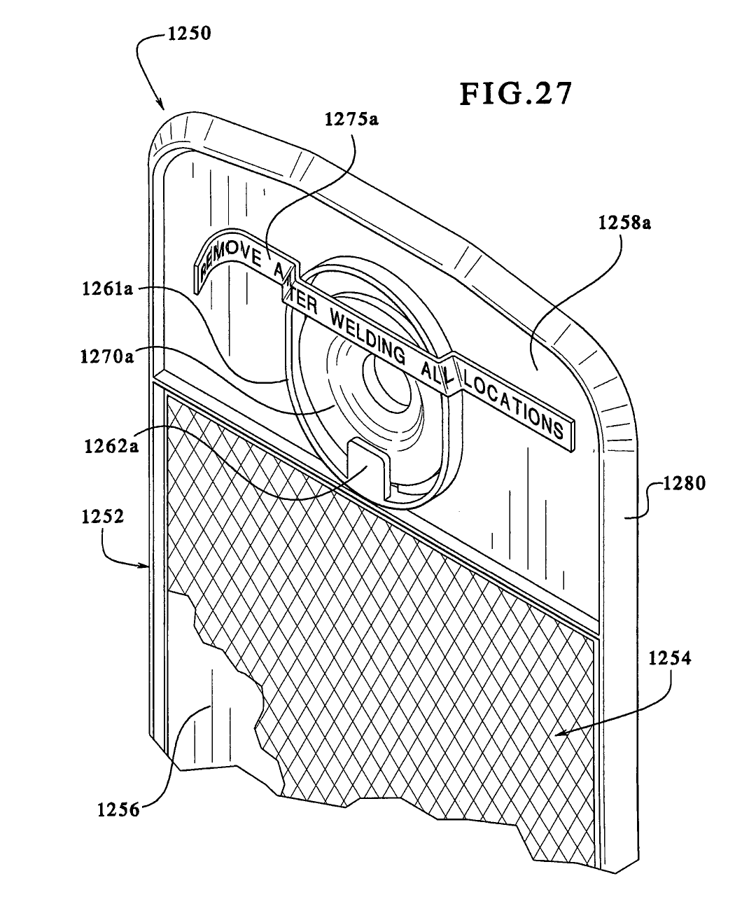

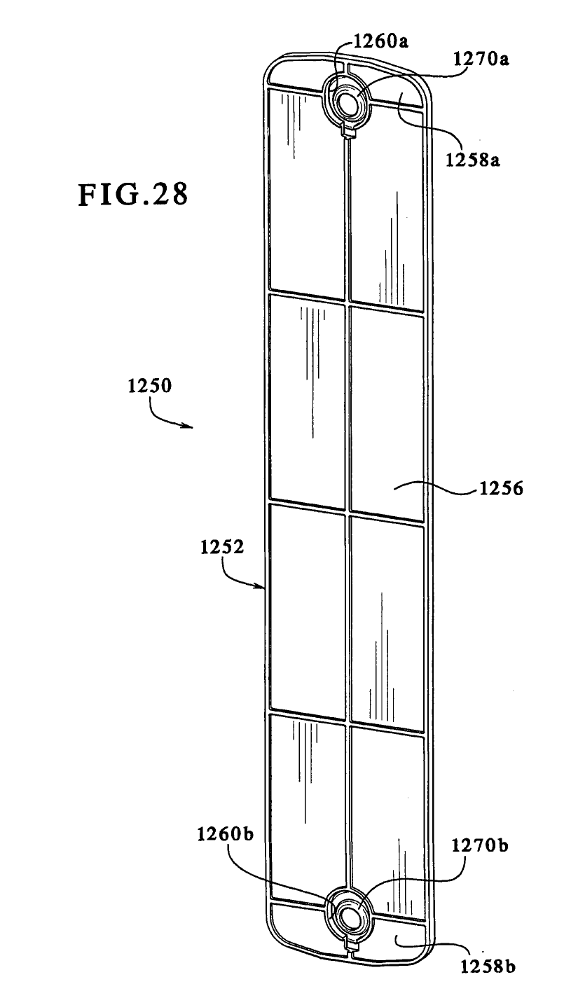

FIGS. 26, 27 and 28 illustrate another embodiment of the reflector apparatus of the present invention which is generally indicated by numeral 1250. The railroad car reflector apparatus 1250 is identical to the reflector apparatus of FIGS. 22, 23, 24 and 25, except that it also includes removable weld washer holders 1275a and 1275b as discussed below.

More specifically, railroad car reflector apparatus 1250 includes a mounting member or base 1252, a reflector 1254 attached to a reflector supporter 1256 of the mounting member or base 1252, and mounting sections 1258a and 1258b connected to and extending from the reflector supporter 1256. The mounting sections 1258a and 1258b respectively define mounting apertures 1260a and 1260b suitably sized to receive a portion of weld washers 1270a and 1270b to facilitate attachment of the reflector apparatus 1250 to the freight railroad car. The weld washers 1270a and 1270b respectively extend beyond the mounting apertures 1260a and 1260b to provide a sufficient purchase area to enable the weld washers to maintain the mounting sections 1258a and 1258b (and the entire reflector apparatus 1250) to the freight railroad car when the weld washers are welded to the freight railroad car.

The mounting sections 1258a and 1258b have weld washer guides 1261a and 1261b, weld washer holders or tabs 1262a and 1262b and removable weld washer holders 1275a and 1275b which further hold or maintain the weld washers to prevent the weld washers 1270a and 1270b from falling out of the mounting apertures after assembly and prior to or during the welding process. The guides 1261a and 1261b, the weld washer holders or tabs 1162a and 1162b and the removable weld washer holders 1275a and 1275b coact to maintain the weld washers 1270a and 1270b in position for welding. This reflector apparatus 1250 can be provided fully assembled where the reflector apparatus has the two weld washers attached to the mounting sections. It should be appreciated that the removable weld washer holders 1275a and 1275b maintain the weld washers 1270a and 1270b in position for welding even if the railroad car reflector is placed on the car in a horizontal position. After welding, the removable weld washer holders 1275a and 1275b are removed. This facilitates the movement of the reflector apparatus relative to the stationary (i.e., welded) weld washers to allow for expansion and contraction. The guides 1261(a) and 1261(b) respectively limit the movement of the reflector apparatus.

It should also be appreciated that the mounting member or base 1252 may have structural supports to provide substantial rigidity to the mounting member or base 1252 and the entire reflector apparatus 1250. Any suitable structural supports may be employed in the reflector apparatus to provide such rigidity. The supports of the reflector apparatus 1250 also define an outer raised border, air deflector or air foil 1280. In one embodiment, because the air deflector or air foil is along all of the edges, the air deflector works to protect the leading edge whether the reflector apparatus 1250 is placed in a vertical or horizontal position. This border, air deflector or air foil functions to deflect or redirect wind from engaging the leading edge of the reflector 1254. This prevents peeling of the reflector material from the mounting member 1252.

It should also be appreciated that the reflector supporter of the present invention can be recessed relative to the rest of the mounting member to protect the edges of the reflector material.

The reflector apparatus 1250 may be made from any suitable material(s). The mounting member or base may be any suitable type of material such as a molded plastic or a stamped metal. The reflector 1254 of the reflector apparatus 1250 is in one embodiment a suitable adhesive backed reflective tape such as the reflective tape commercially available as mentioned above. It should also be appreciated that other suitable types of reflective material or reflectors may be employed in the railroad car reflector apparatus of the present invention. The removable weld washer holders 1275a and 1275b in one embodiment are made from a single sided adhesive tape.

It should be appreciated that the railroad car reflector or reflector apparatus of the present invention can be formed with any suitable number or combination of attachment mechanism, guides, and removable or non-removable holders. For instance, in one embodiment, a plurality of holders are positioned around the mounting aperture. In another embodiment, a plurality of removable holders are employed to maintain the attachment mechanism or weld washer in the mounting aperture. It should also be appreciated that the configuration, shape and size of the guides and holders may vary.

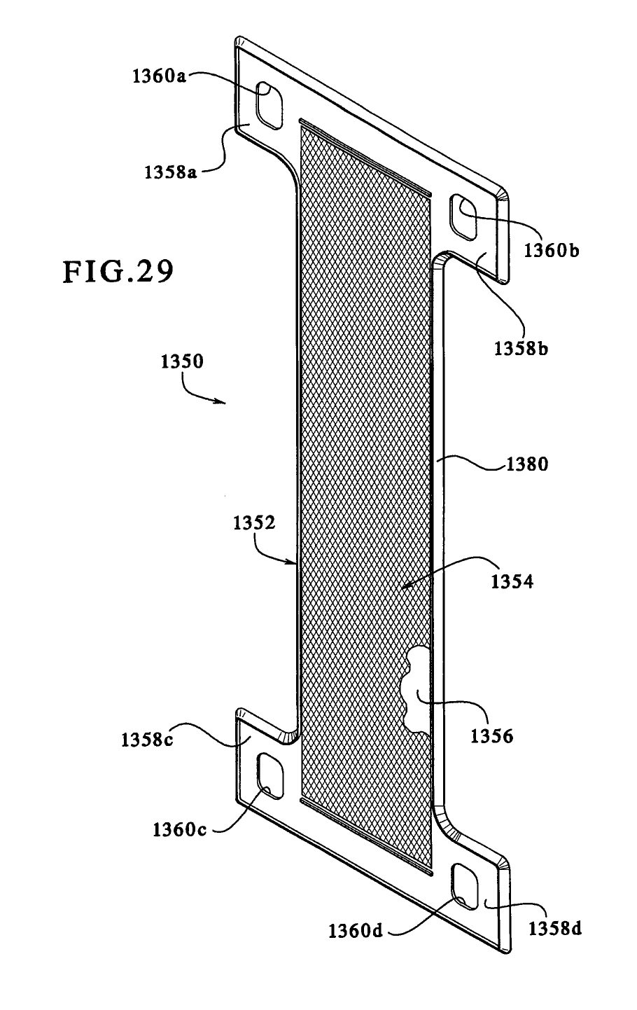

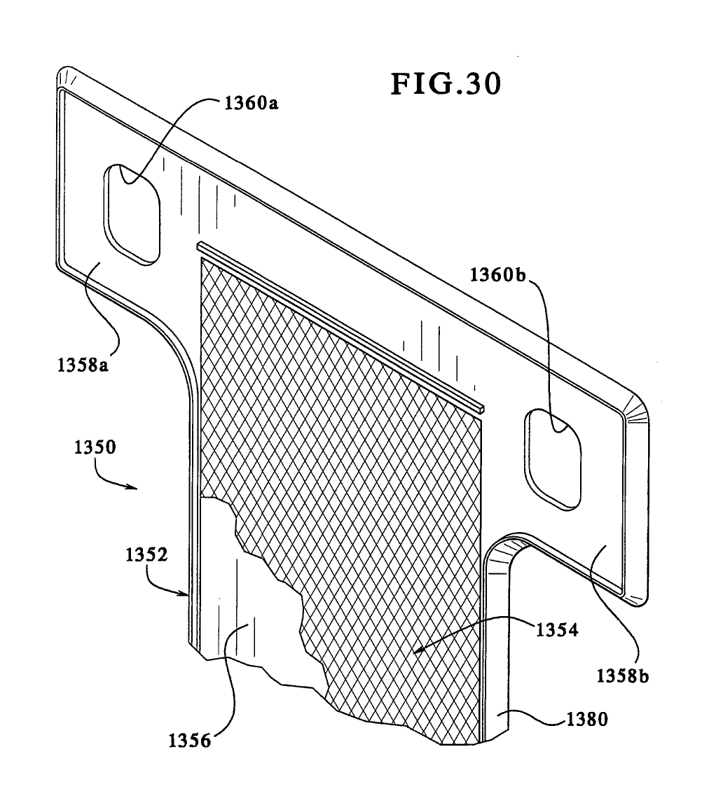

FIGS. 29 and 30 illustrate another embodiment of the reflector apparatus of the present invention which is generally indicated by numeral 1350. The railroad car reflector apparatus 1350 includes a mounting member or base 1352 and a reflector 1354 suitably attached to the mounting member or base 1352. The mounting member or base 1352 includes a reflector supporter 1356 and mounting sections 1358a, 1358b, 1358c and 1358d connected to the reflector supporter 1356. The mounting sections 1358a, 1358b, 1358c and 1358d extend from opposing ends of the reflector supporter 1356 and transversely from opposing sides of the reflector supporter 1356 in this embodiment. The mounting sections 1358a, 1358b, 1358c and 1358d respectively define mounting apertures 1360a, 1360b, 1360c and 1360d for facilitating attachment of the reflector apparatus 1350 to the freight railroad car, and more particularly to an autorack railroad car as further discussed below. It should be appreciated that the shape of the mounting apertures can vary for this embodiment and the other embodiments disclosed herein. It should be appreciated that in one embodiment, the ends of the mounting aperture are more rounded. In further embodiments the mounting apertures are oval.

The reflector apparatus 1350 also includes suitable fasteners or attachment mechanisms for attaching the mounting member or base 1352 to the freight railroad car such as the fasteners or attachment mechanisms discussed above in regard to FIGS. 4 and 5. The fasteners may be any suitable type of fastener which can attach the mounting sections to the autorack railroad car sidewall panel screens. One such type of fastener is described in U.S. Pat. No. 5,239,933. Other suitable types of commercially available fasteners may be employed in accordance with the present invention.

Each mounting section defines a mounting aperture which is shaped and sized to receive the fastener in multiple positions. In the illustrated embodiment, the mounting apertures 1360a, 1360b, 1360c and 1360d are each symmetrically shaped to facilitate attachment of the reflector apparatus in a horizontal or substantially horizontal position relative to the autorack railroad car.

The reflector apparatus 1350 may be made from any suitable material(s). The mounting member or base 1352 may be any suitable type of material such as a molded plastic or a stamped metal. The reflector 1354 of the reflector apparatus 1350 is in one embodiment a suitable adhesive backed reflective tape such as a reflective tape commercially available as mentioned above.

To install the reflector apparatus 1350 on autorack railroad car, the installer simply takes the reflector apparatus and holds it adjacent to the exterior autorack railroad car side wall panel screen in the appropriate position and inserts the fasteners in each of the mounting apertures and through the holes in the side wall panel screen.

It should also be appreciated that the mounting member or base 1352 may have structural supports such as supports or ribs (not shown) to provide substantial rigidity to the mounting member or base 1352 and the entire reflector apparatus 1350. Any suitable structural supports may be employed in the reflector apparatus to provide such rigidity. The supports of the reflector apparatus 1350 define an outer raised border, air deflector or air foil 1380. This border, air deflector or air foil 1380 functions to deflect or redirect wind from engaging the leading edge of the reflector 1354. This prevents peeling of the reflector from the mounting member 1352. It should also be appreciated that the reflector supporter of the present invention can be recessed relative to the rest of the mounting member to protect the edges of the reflector.

In an alternative embodiment, the installer can drill a hole in the freight railroad car aligned with the mounting aperture and use a blind rivet to attach the mounting member to the freight railroad car instead of welding. In this embodiment, the mounting apertures may be considerably smaller. In one such embodiment, a weld washer with a smaller hole is used in conjunction with the rivet to provide a sufficiently sized purchase area.

It should be appreciated that the mounting member provides a contrast to the reflector in one embodiment to make the reflector more viewable. In one such embodiment, the mounting member is black and the reflector is yellow.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The following is claimed:

1. A freight railroad car reflector apparatus comprising:
a mounting member including:
(a) a reflector supporter having opposing first and second ends,
(b) a first mounting section connected to and extending from the first end of the reflector supporter, said first mounting section defining a first mounting aperture configured to facilitate attachment of said first mounting section by a first attachment mechanism to a freight railroad car, and
(c) a second mounting section connected to and extending from the second end of the reflector supporter, said second mounting section defining a second mounting aperture configured to facilitate attachment of said second mounting section by a second attachment mechanism to the freight railroad car; and
a reflector adhesively attached to the reflector supporter, said reflector including an adhesive backed reflective tape.

2. The freight railroad car reflector of claim 1, wherein at least one of the mounting sections extends transversely from opposing sides of the reflector supporter.

3. The freight railroad car reflector of claim 1, wherein each of the mounting sections extends transversely from opposing sides of the reflector supporter.

4. The freight railroad car reflector of claim 1, wherein the mounting member includes an air deflector extending along at least one outer edge.

5. The freight railroad car reflector of claim 1, wherein the mounting member includes an air deflector extending around its entire outer edge.

6. The freight railroad car reflector of claim 1, wherein the reflector supporter includes a recessed reflector receipt area configured to protect edges of the reflective tape.

7. The freight railroad car reflector of claim 1, wherein the first attachment mechanism is maintainable in the first mounting aperture by the first mounting section and the second attachment mechanism is maintainable in the second mounting aperture by the second mounting section.

8. The freight railroad car reflector of claim 1, wherein the first attachment mechanism is maintainable in the first mounting aperture by a first holder and the second attachment mechanism is maintainable in the second mounting aperture by a second holder.

9. A freight railroad car reflector apparatus comprising:
a mounting member including:
(a) a reflector supporter having opposing first and second ends,
(b) a first mounting section connected to and extending from the first end of the reflector supporter, said first mounting section defining a first mounting aperture, and
(c) a second mounting section connected to and extending from the second end of the reflector supporter, said second mounting section defining a second mounting aperture;
a first weld washer maintained in the first mounting aperture for facilitating attachment of the first mounting section to a freight railroad car;
a second weld washer maintained in the second mounting aperture for facilitating attachment of the second mounting section to the freight railroad car; and
a reflector adhesively attached to the reflector supporter, said reflector including an adhesive backed reflective tape.

10. The freight railroad car reflector of claim 9, wherein the mounting member includes an air deflector extending along at least one outer edge.

11. The freight railroad car reflector of claim 9, wherein the mounting member includes an air deflector extending around its entire outer edge.

12. The freight railroad car reflector of claim 9, wherein the reflector supporter includes a recessed reflector receipt area configured to protect edges of the reflective tape.

13. A freight railroad car reflector apparatus comprising:
a mounting member including:
(a) a reflector supporter having opposing first and second ends,
(b) a first mounting section connected to and extending from the first end of the reflector supporter, said first mounting section defining a first mounting aperture, and
(c) a second mounting section connected to and extending from the second end of the reflector supporter, said second mounting section defining a second mounting aperture;
a first weld washer molded in the first mounting aperture for facilitating attachment of the first mounting section to a freight railroad car;
a second weld washer molded in the second mounting aperture for facilitating attachment of the second mounting section to the freight railroad car; and
a reflector adhesively attached to the reflector supporter, said reflector including an adhesive backed reflective tape.

14. The freight railroad car reflector of claim 13, wherein the mounting member includes an air deflector extending along at least one outer edge.

15. The freight railroad car reflector of claim 13, wherein the mounting member includes an air deflector extending around its entire outer edge.

16. The freight railroad car reflector of claim 13, wherein the reflector supporter includes a recessed reflector receipt area configured to protect edges of the reflective tape.

17. A freight railroad car reflector apparatus comprising:
a mounting member including
(a) a reflector supporter having opposing first and second ends,
(b) a first mounting section connected to and extending from the first end of the reflector supporter, said first mounting section defining a first mounting aperture, said first mounting section including a first holder integrally formed with the first mounting section and configured to hold a first weld washer in the first mounting aperture for facilitating attachment of the first mounting section to a freight railroad car, and
(c) a second mounting section connected to and extending from the second end of the reflector supporter, said second mounting section defining a second mounting aperture,
said second mounting section including a second holder integrally formed with the second mounting section and configured to hold a second weld washer in the second mounting aperture for facilitating attachment of the second mounting section to the freight railroad car; and
a reflector adhesively attached to the reflector supporter, said reflector including an adhesive backed reflective tape.

18. The freight railroad car reflector of claim 17, wherein the first mounting section includes a first weld washer guide and wherein the second mounting section includes a second weld washer guide.

19. The freight railroad car reflector of claim 17, wherein the mounting member includes an air deflector extending along at least one outer edge.

20. The freight railroad car reflector of claim 17, wherein the mounting member includes an air deflector extending around its entire outer edge.

21. The freight railroad car reflector of claim 17, wherein the reflector supporter includes a recessed reflector receipt area configured to protect edges of the reflective tape.

22. A freight railroad car reflector apparatus comprising:
a mounting member including
(a) a reflector supporter having opposing first and second ends,
(b) a first mounting section connected to and extending from the first end of the reflector supporter, said first mounting section defining a first mounting aperture, said first mounting section including a first holder integrally formed with the first mounting section and configured to hold a first weld washer in the first mounting aperture, and
(c) a second mounting section connected to and extending from the second end of the reflector supporter, said second mounting section defining a second mounting aperture,
said second mounting section including a second holder integrally formed with the second mounting section and configured to hold a second weld washer in the second mounting aperture; and
a first weld washer maintained in the first mounting aperture by the first holder for facilitating attachment of the first mounting section to a freight railroad car;
a second weld washer maintained in the second mounting aperture by the second holder for facilitating attachment of the second mounting section to the freight railroad car; and
a reflector attached to the reflector supporter, said reflector including an adhesive backed reflective tape.

23. The freight railroad car reflector of claim 22, wherein the first mounting section includes a first weld washer guide and wherein the second mounting section includes a second weld washer guide.

24. The freight railroad car reflector of claim 22, wherein the mounting member includes an air deflector extending along at least one outer edge.

25. The freight railroad car reflector of claim 22, wherein the mounting member includes an air deflector extending around its entire outer edge.

26. The freight railroad car reflector of claim 22, wherein the reflector supporter includes a recessed reflector receipt area configured to protect edges of the reflective tape.

27. A freight railroad car reflector apparatus comprising:
a mounting member including
(a) a reflector supporter having opposing first and second ends,
(b) a first mounting section connected to and extending from the first end of the reflector supporter, said first mounting section defining a first mounting aperture, said first mounting section including a first holder removably attached to the first mounting section and configured to hold a first weld washer in the first mounting aperture for facilitating attachment of the first mounting section to a freight railroad car, and
(c) a second mounting section connected to and extending from the second end of the reflector supporter, said second mounting section defining a second mounting aperture,
said second mounting section including a second holder removably attached to the second mounting section and configured to hold a second weld washer in the second mounting aperture for facilitating attachment of the second mounting section to the freight railroad car; and
a reflector adhesively attached to the reflector supporter, said reflector including an adhesive backed reflective tape.

28. The freight railroad car reflector of claim 27, wherein the mounting member includes an air deflector extending along at least one outer edge.

29. The freight railroad car reflector of claim 27, wherein the mounting member includes an air deflector extending around its entire outer edge.

30. The freight railroad car reflector of claim 27, wherein the reflector supporter includes a recessed reflector receipt area configured to protect edges of the reflective tape.

31. A freight railroad car reflector apparatus comprising:
a mounting member including
(a) a reflector supporter having opposing first and second ends,
(b) a first mounting section connected to and extending from the first end of the reflector supporter, said first mounting section defining a first mounting aperture, said first mounting section including a first holder removably attached to the first mounting section and configured to hold a first weld washer in the first mounting aperture, and
(c) a second mounting section connected to and extending from the second end of the reflector supporter, said second mounting section defining a second mounting aperture,
said second mounting section including a second holder removably attached to the second mounting section and configured to hold a second weld washer in the second mounting aperture; and
a first weld washer maintained in the first mounting aperture by the first holder for facilitating attachment of the first mounting section to a freight railroad car;
a second weld washer maintained in the second mounting aperture by the second holder for facilitating attachment of the second mounting section to the freight railroad car; and
a reflector attached to the reflector supporter, said reflector including an adhesive backed reflective tape.

32. The freight railroad car reflector of claim 31, wherein the mounting member includes an air deflector extending along at least one outer edge.

33. The freight railroad car reflector of claim 31, wherein the mounting member includes an air deflector extending around its entire outer edge.

34. The freight railroad car reflector of claim 31, wherein the reflector supporter includes a recessed reflector receipt area configured to protect edges of the reflective tape.

35. A freight railroad car reflector apparatus comprising:
a mounting member including
(a) a reflector supporter having opposing first and second ends,
(b) a first mounting section connected to and extending from the first end of the reflector supporter, said first mounting section defining a first mounting aperture, said first mounting section including a first holder integrally formed with and a first removable holder removably attached to the first mounting section and configured to hold a first weld washer in the first mounting aperture for facilitating attachment of the first mounting section to a freight railroad car, and
(c) a second mounting section connected to and extending from the second end of the reflector supporter, said second mounting section defining a second mounting aperture,
said second mounting section including a second holder integrally formed with and a second removable holder removably attached to the second mounting section and configured to hold a second weld washer in the second mounting aperture for facilitating attachment of the second mounting section to the freight railroad car; and
a reflector adhesively attached to the reflector supporter, said reflector including an adhesive backed reflective tape.

36. The freight railroad car reflector of claim 35, wherein the first mounting section includes a first weld washer guide and wherein the second mounting section includes a second weld washer guide.

37. The freight railroad car reflector of claim 35, wherein the mounting member includes an air deflector extending along at least one outer edge.

38. The freight railroad car reflector of claim 35, wherein the mounting member includes an air deflector extending around its entire outer edge.

39. The freight railroad car reflector of claim 35, wherein the reflector supporter includes a recessed reflector receipt area configured to protect edges of the reflective tape.

40. A freight railroad car reflector apparatus comprising:
a mounting member including
(a) a reflector supporter having opposing first and second ends,
(b) a first mounting section connected to and extending from the first end of the reflector supporter, said first mounting section defining a first mounting aperture, said first mounting section including a first holder integrally formed with and a first removable holder removably attached to the first mounting section and configured to hold a first weld washer in the first mounting aperture, and
(c) a second mounting section connected to and extending from the second end of the reflector supporter, said second mounting section defining a second mounting aperture,
said second mounting section including a second holder integrally formed with and a second removable holder removably attached to the second mounting section and configured to hold a second weld washer in the second mounting aperture; and
a first weld washer maintained in the first mounting aperture by the first holder and the first removable holder for facilitating attachment of the first mounting section to a freight railroad car;
a second weld washer maintained in the second mounting aperture by the second holder and the second removable holder for facilitating attachment of the second mounting section to the freight railroad car; and
a reflector attached to the reflector supporter, said reflector including an adhesive backed reflective tape.

41. The freight railroad car reflector of claim 40, wherein the first mounting section includes a first weld washer guide and wherein the second mounting section includes a second weld washer guide.

42. The freight railroad car reflector of claim 40, wherein the mounting member includes an air deflector extending along at least one outer edge.

43. The freight railroad car reflector of claim 40, wherein the mounting member includes an air deflector extending around its entire outer edge.

44. The freight railroad car reflector of claim 40, wherein the reflector supporter includes a recessed reflector receipt area configured to protect edges of the reflective tape.

50. An autorack railroad car reflector apparatus comprising:
a mounting member including:
(a) a reflector supporter, and
(b) a plurality of mounting sections connected to and extending from the reflector supporter, said mounting sections defining a plurality of first mounting apertures, each first mounting aperture configured to facilitate attachment of the mounting member to an autorack railroad car by one of a plurality of fasteners; and
a reflector attached to the reflective supporter, said reflector including an adhesive backed reflective tape.

51. The autorack railroad car reflector of claim 50, each of said mounting apertures is configured to receive the respective fastener in a vertical or substantially vertical position relative to the autorack railroad car or in a horizontal or substantially horizontal position relative to the autorack railroad car, said mounting apertures each have a first diameter which allows for expansion and contraction of the mounting member and a second different diameter which allows for expansion and contraction of the mounting member, said first and second diameters being substantially transverse to each other.

52. The autorack railroad car reflector of claim 50, wherein the mounting member includes an air deflector extending along at least one outer edge.

53. The autorack railroad car reflector of claim 50, wherein the mounting member includes an air deflector extending around its entire outer edge.

54. The autorack railroad car reflector of claim 50, wherein the reflector supporter includes a recessed reflector receipt area configured to protect edges of the reflective tape.

55. An autorack railroad car reflector apparatus comprising:
a mounting member including:
(a) a reflector supporter having opposing first and second ends and opposing sides,
(b) a first mounting section connected to and extending from the first end of the reflector supporter, extending and transversely from the opposing sides of the reflector supporter, said first mounting section defining a plurality of first mounting apertures, each first mounting aperture configured to facilitate attachment of the mounting member to an autorack railroad car by one of a plurality of fasteners, and
(c) a second mounting section connected to and extending from the second end of the reflector supporter, extending and transversely from the opposing sides of the reflector supporter, said second mounting section defining a plurality of second mounting apertures, each second mounting aperture configured to facilitate attachment of the mounting member to said autorack railroad car by one of a plurality of the fasteners,
a reflector attached to the reflective supporter, said reflector including an adhesive backed reflective tape.

56. The autorack railroad car reflector of claim 55, each of said mounting apertures is configured to receive the respective fastener in a vertical or substantially vertical position relative to the autorack railroad car or in a horizontal or substantially horizontal position relative to the autorack railroad car, said mounting apertures each have a first diameter which allows for expansion and contraction of the mounting member and a second different diameter which allows for expansion and contraction of the mounting member, said first and second diameters being substantially transverse to each other.

57. The autorack railroad car reflector of claim 55, wherein the mounting member includes an air deflector extending along at least one outer edge.

58. The autorack railroad car reflector of claim 55, wherein the mounting member includes an air deflector extending around its entire outer edge.

59. The autorack railroad car reflector of claim 55, wherein the reflector supporter includes a recessed reflector receipt area configured to protect edges of the reflective tape.
